(19) United States
(12) Patent Application Publication
(10) Pub. No.: US 2021/0092640 A1
(43) Pub. Date: Mar. 25, 2021

(54) NEXT GENERATION GLOBAL SATELLITE SYSTEM WITH MEGA-CONSTELLATIONS

(71) Applicant: HUGHES NETWORK SYSTEMS, LLC, Germantown, MD (US)

(72) Inventors: Channasandra RAVISHANKAR, Germantown, MD (US); Rajeev GOPAL, Germantown, MD (US); Nassir BENAMMAR, Germantown, MD (US); Gaguk ZAKARIA, Germantown, MD (US); Xiaoling HUANG, Germantown, MD (US)

(73) Assignee: HUGHES NETWORK SYSTEMS, LLC, Germantown, MD (US)

(21) Appl. No.: 17/030,291

(22) Filed: Sep. 23, 2020

Related U.S. Application Data
(60) Provisional application No. 62/904,594, filed on Sep. 23, 2019.

(51) Int. Cl. H04W 28/08; H04B 7/185; H04W 48/18; H04L 12/865; H04W 28/02

(52) U.S. Cl. CPC H04W 28/0819; H04B 7/18513; H04W 28/0967; H04L 47/6275; H04W 28/0268; H04W 48/18

(57) ABSTRACT

A system for providing communication using a plurality of radio access technologies is disclosed. The system utilizes terminals capable of communicating with the plurality of radio access technologies. The terminals are capable of selecting the most suitable radio access technology for different types traffic. Different radios access technologies are further capable of cross-communication in order to route traffic over the most efficient paths.

### CROSS-REFERENCE TO RELATED APPLICATION

The present application claims priority to U.S. Provisional Patent Application No. 62/904,594 filed Sep. 23, 2019, and entitled “Next Generation Global Satellite System With Mega-Constellations”, the entire disclosure of which is incorporated herein by reference.

### BACKGROUND INFORMATION

Satellite communication services have become more accessible to consumers due to increased availability and reduced service costs. Satellite communication systems allow consumers to access voice and data services from virtually any global location. Such accessibility can be beneficial for consumers who are located in, or must travel to, areas that cannot be reliably serviced by normal voice and/or data communication systems. Satellite communication bandwidth, however, remains expensive relative to terrestrial landline and wireless services. Satellite service providers continually seek to utilize the most capacity available, while also attempting to increase overall system capacity.

The use of high throughput satellite (HTS) systems to provide voice and data access has resulted in greater speed and higher throughput for consumers in areas that may lack cellular or landline infrastructure. HTS systems typically employ multiple gateways (or satellite hubs) to provide service to customers utilizing very small aperture terminals (VSATs, or simply “terminals). Gateways can assign frequencies to terminals, such that terminals can transmit data to the gateway (and receive data from the gateway) using the assigned transmit frequencies.

The terminals (i.e., satellite terminal) used by such satellite communication systems are generally capable of communicating with a single satellite network. For example, such terminals can be configured for communicating with a low earth orbit (LEO) constellation of satellites or a medium earth orbit (MEO) constellation of satellites. The terminals can also be configured to communicate with a geostationary equatorial orbit (GEO) satellite. As consumers desire increased amounts of content for applications such as virtual and/or augmented reality, communication via a single radio access technology (RAT) can become inefficient for maintaining a desired quality of service. Furthermore, since the maximum bandwidth of satellite communication systems is generally static and cannot be raised, it can become difficult to accommodate increased user traffic demands.

Based on the foregoing, there is a need for an approach for selectively utilizing multiple RATs to improve throughput and quality of service in satellite communication systems.

### BRIEF SUMMARY

An apparatus method, and system are disclosed for providing integrated communication using a plurality of radio access technologies. According to an embodiment, the method includes: establishing a communication link using a terminal configured for communicating with a plurality of radio access technologies (RATs); determining a priority for network traffic associated with the terminal based, at least in part, on delay sensitivity associated with the network traffic; classifying the plurality of RATs based on suitability for carrying the network traffic having the determined priority; transmitting and receiving the network traffic using the RAT most suitable for carrying the network traffic and available to the terminal; and dynamically monitoring RATS available to the terminal to detect if a more suitable RAT becomes available for carrying the network traffic.

The foregoing summary is only intended to provide a brief introduction to selected features that are described in greater detail below in the detailed description. As such, this summary is not intended to identify, represent, or highlight features believed to be key or essential to the claimed subject matter. Furthermore, this summary is not intended to be used as an aid in determining the scope of the claimed subject matter.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing of voice and data services, according to at least one embodiment;

FIG. 2 is a diagram of a mega constellation system for supporting diverse 5G use cases, in accordance with various embodiments;

FIG. 3 is a diagram of a hybrid communication architecture for next generation satellite systems;

FIG. 4 is a diagram of protocol stacks for a hybrid communication system, in accordance to one or more embodiments;

FIG. 5 is a diagram of a protocol stack for a hybrid communication system, in accordance to an embodiment;

FIG. 6 is a diagram of a terrestrial/LEO/MEO/GEO system topology with 5G core network, in accordance with one or more embodiments;

FIG. 7 is a diagram of network topology for terminal having multiple radio access;

FIG. 8 is a diagram illustrating beam to beam handover;

FIG. 9 is a diagram of a paging process for terrestrial access via LEO access;

FIG. 10 is a diagram of traffic Estimation and route determination timelines for a mega constellation satellite ground network, in accordance with various embodiments;

FIG. 11 is a diagram of 5G QoS architecture, in accordance with one or more embodiments;

FIG. 12 is a diagram of dual connectivity terrestrial and LEO access, according to at least one embodiment;

FIG. 13 is a diagram of a configuration for multiple constellations with DSM IPv6, according to one or more embodiments;

FIG. 14 is a diagram of dual connectivity for multiple constellations to enable the throughput aggregation;

FIG. 15 is a diagram of a system with traffic detector and traffic management entity;

FIG. 16 is a diagram of 5G Session and service continuity (SSC) according to an embodiment;

FIG. 17 is a diagram of signal and interference impact in terrestrial frequency reuse;

FIG. 18A is a plot of attenuation experience by Q/V band signals compared to Ka band signals;

FIG. 18B is a plot of the correlation coefficient of simultaneous rain in diversity sites as a function of distance;

FIG. 19A is a diagram of an inline event between MEO gateway and LEO satellite;

FIG. 19B is a plot of the location of interferer with respect to a return link beam;

FIG. 19C is a plot of beam response suppression with respect to known interferers;

FIG. 19D is a plot of the use of co-channel suppression to achieve higher throughputs;

FIG. 20A is a diagram of non-uniform reuse factor implementation;

FIG. 20B is a diagram of time-varying loading of beams when serving hot-spots according to an embodiment;

FIG. 21 is a plot of a non-uniform traffic pattern in different reuse cells;

FIG. 22 is a plot of Spectral efficiency improvement achieved by location aware scheduling of the traffic pattern shown in FIG. 21;

FIG. 23 illustrates the location of co-channel interferers in a return link based on beam response;

FIG. 24 is a diagram of a computer system that can be used to implement various exemplary features and embodiments; and

FIG. 25 is a diagram of a chip set that can be used to implement various exemplary features and embodiments.

### DETAILED DESCRIPTION

A system, apparatus, and method for providing integrated communication using a plurality of radio access technologies (RATs) are described. In the following description, for purposes of explanation, numerous specific details are set forth in order to provide a thorough understanding of the disclosed embodiments. It will become apparent, however, to one skilled in the art that various embodiments may be practiced without these specific details or with an equivalent arrangement. In other instances, well-known structures and devices are shown in block diagram form in order to avoid unnecessarily obscuring the various embodiments.

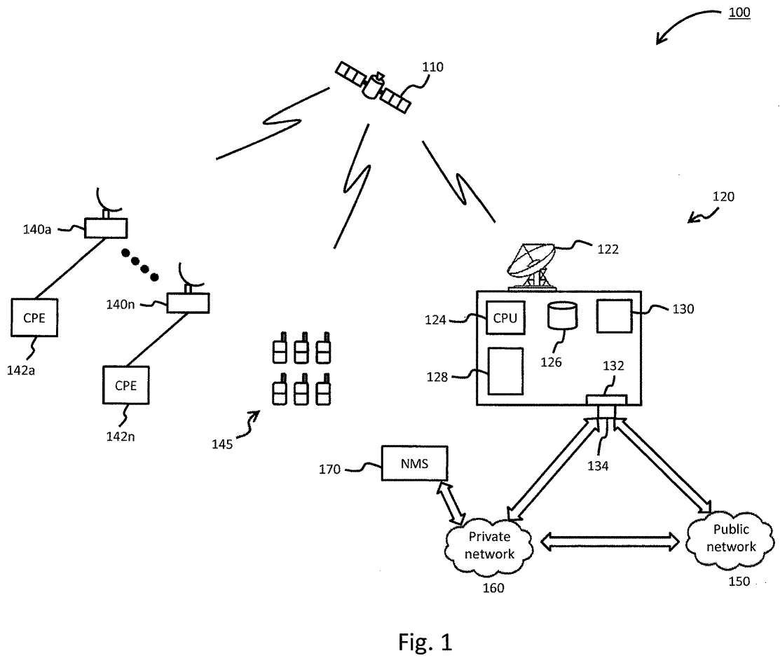

FIG. 1 illustrates a satellite communication system 100 capable of providing voice and data services. The satellite communication system 100 includes a satellite 110 that supports communications among a number of gateways 120 (only one shown) and multiple stationary satellite terminals 140a-140n. Each satellite terminal (or terminal) 140 can be configured for relaying traffic between its customer premise equipment (CPEs) 142a-142n (i.e., user equipment), a public network 150 such as the internet, and/or its private network 160. Depending on the specific embodiment, the customer premise equipment 142 can be a desktop computer, laptop, tablet, cell phone, etc. Customer premise equipment 142 can also be in the form of connected appliances that incorporate embedded circuitry for network communication can also be supported by the satellite terminal. Connected appliances can include, without limitation, televisions, home assistants, thermostats, refrigerators, ovens, etc. The network of such devices is commonly referred to as the internet of things (IoT).

According to an exemplary embodiment, the terminals 140 can be in the form of very small aperture terminals (VSATs) that are mounted on a structure, habitat, etc. Depending on the specific application, however, the terminal 140 can incorporate an antenna dish of different sizes (e.g., small, medium, large, etc.). The terminals 140 typically remain in the same location once mounted, unless otherwise removed from the mounting. According various embodiments, the terminals 140 can be mounted on mobile platforms that facilitate transportation thereof from one location to another. Such mobile platforms can include, for example, cars, buses, boats, planes, etc. The terminals 140 can further be in the form of transportable terminals capable of being transported from one location to another. Such transportable terminals are operational only after arriving at a particular destination, and not while being transported.

As illustrated in FIG. 1, the satellite communication system 100 can also include a plurality of mobile terminals 145 that are capable of being transported to different locations by a user. In contrast to transportable terminals, the mobile terminals 145 remain operational while users travel from one location to another. The terms user terminal, satellite terminal, terminal may be used interchangeably herein to identify any of the foregoing types. The gateway 120 can be configured to route traffic from stationary, transportable, and mobile terminals (collectively terminals 140) across the public network 150 and private network 160 as appropriate. The gateway 120 can be further configured to route traffic from the public internet 150 and private network 160 across the satellite link to the appropriate terminal 140. The terminal 140 then routes the traffic to the appropriate customer premise equipment (CPE) 142.

According to at least one embodiment, the gateway 120 can include various components, implemented in hardware, software, or a combination thereof, to facilitate communication between the terminals 140 and external networks 150, 160 via the satellite 110. According to an embodiment, the gateway 120 can include a radio frequency transceiver 122 (RFT), a processing unit 124 (or computer, CPU, etc.), and a data storage unit 126 (or storage unit). While generically illustrated, the CPU 124 can encompass various configurations including, without limitations, a personal computer, laptop, server, etc. As used herein, a transceiver corresponds to any type of antenna unit used to transmit and receive signals, a transmitter, a receiver, etc. The RFT is useable to transmit and receive signals within a communication system such as the satellite communication system 100 illustrated in FIG. 1. The data storage unit 126 can be used, for example, to store and provide access to information pertaining to various operations in the satellite communication system 100. Depending on the specific implementation, the data storage unit 126 (or storage unit) can be configured as a single drive, multiple drives, an array of drives configured to operate as a single drive, etc.

According to other embodiments, the gateway 120 can include multiple processing units 124 and multiple data storage units 126 in order to accommodate the needs of a particular system implementation. Although not illustrated in FIG. 1, the gateway 120 can also include one or more workstations 125 (e.g., computers, laptops, etc.) in place of, or in addition to, the one or more processing units 124. Various embodiments further provide for redundant paths for components of the gateway 120. The redundant paths can be associated with backup components capable of being seamlessly or quickly switched in the event of a failure or critical fault of the primary component.

According to the illustrated embodiment, the gateway 120 includes baseband components 128 which operate to process signals being transmitted to, and received from, the satellite 110. For example, the baseband components 128 can incorporate one or more modulator/demodulator units, system timing equipment, switching devices, etc. The modulator/demodulator units can be used to generate carriers that are transmitted into each spot beam and to process signals received from the terminals 140. The system timing equipment can be used to distribute timing information for synchronizing transmissions from the terminals 140.

According to an embodiment, a fault management unit 130 can be included in the gateway 120 to monitor activities and output one or more alerts in the event of a malfunction in any of the gateway components. The fault management unit 130 can include, for example, one or more sensors and interfaces that connect to different components of the gateway 120. The fault management unit 130 can also be configured to output alerts based on instructions received from a remotely located network management system 170 (NMS). The NMS 170 maintains, in part, information (configuration, processing, management, etc.) for the gateway 120, and all terminals 140 and beams supported by the gateway 120. The gateway 120 can further include a network interface 132, such as one or more edge routers, for establishing connections with a terrestrial connection point 134 from a service provider. Depending on the specific implementation, however, multiple terrestrial connection points 134 may be utilized.

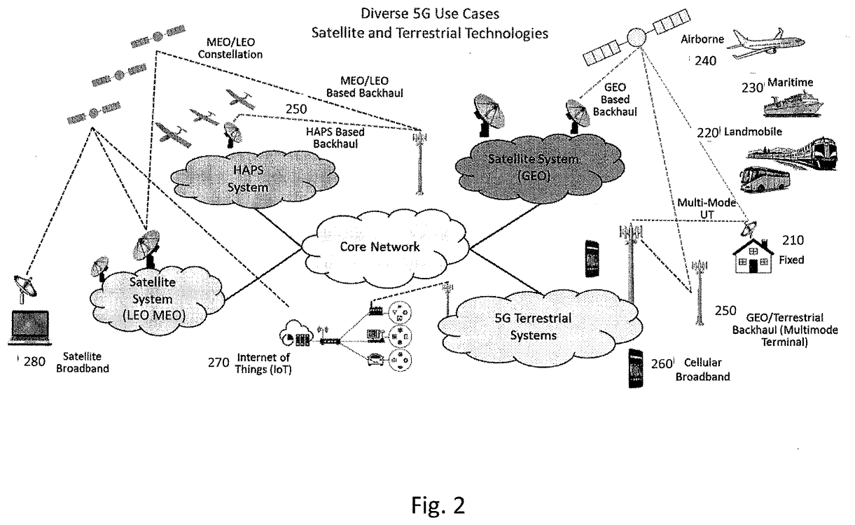

FIG. 2 illustrates a mega constellation system for supporting diverse 5G use cases, in accordance with various embodiments. FIG. 2 illustrates multiple types of communication sessions that can be established. For example, use case 210 illustrates an embodiment wherein an unserved residence, or small commercial building, with initial satellite service and 4G/5G terrestrial service can utilize a multimode UT to gain connectivity in sparsely populated areas. According to the illustrated embodiment connectivity can be established using a GEO satellite, a terrestrial wireless system, or both. According to other embodiments, the UT can further establish connectivity with MEO and/or GEO satellite constellations. Furthermore, if a multimode UT is not available, traffic can optionally be routed between GEO, MEO, and LEO satellites using Inter-Satellite Links (ISL). In such cases, traffic associated with the UT would initiate and terminate with the specific satellite service for which the UT is configured. For example, if the UT is configured to communicate with a MEO satellite constellation, packets would be exchanged with the UT via the MEO satellites and/or a gateway associated with the MEO satellite constellation. However, packets originating from a particular MEO satellite may be routed to multiple other MEO satellites, LEO satellites, and/or GEO satellite using ISLs.

Use case 220 illustrate an embodiment which incorporates ground-based moving platforms (e.g., buses, trains, and automobiles, etc.) wherein consumers require broadband services with guaranteed connectivity across urban and rural areas during the course of long-distance travel to remote locations. Such ground-based platforms can utilize LEO/MEO/GEO satellites as well as terrestrial wireless networks. Use case 230 illustrates an embodiment for maritime platforms, such as a cruise liner. According to such embodiments, the UT can be configured to communicate with terrestrial wireless services near shore and transition to satellite access as it moves off-shore, thereby optimizing service costs irrespective of location. Use case 240 illustrates an embodiment wherein an aircraft provides Wi-Fi access for occupants while taking off, landing, and flying over oceans and unpopulated areas. The UT can be configured to communicate with LEO, MEO, and/or GEO satellites in order to provide continuous service independent of the location of the aircraft. Use case 350 illustrates an embodiment wherein a terrestrial wireless service can leverage backhaul enabled by high-capacity next generation high-throughput satellite (HTS) systems in regions that lack fiber backhaul. According to such embodiments, communication links can be established with GEO satellites for coverage over continents and LEO satellites for coverage over both continents and oceans.

Use case 260 illustrates an embodiment wherein broadband service (4K, 8K video, augmented/virtual reality, etc.) can be provided for mobile and stationary end-user devices irrespective of their location and lack of full 4G/5G terrestrial access using satellite coverage for unserved and underserved areas. According to at least one embodiment, the UT can be configured for concurrent access to terrestrial wireless networks as well as satellites. Use case 270 illustrates an embodiment wherein IoT for smart operations (sensing, control, SCADA) comprising farms, (autonomous) vehicles, factories, oil/gas installations, electric grid, etc. and can benefit from satellites extending 5G coverage to remote areas with low-latency LEO and High altitude platform (HAPS) based service for responsive control of critical devices and vehicles. Use case 280 illustrates an embodiment wherein satellite broadband service can be provided for unserved and underserved areas worldwide.

Hybrid Communications and Protocol Architectures

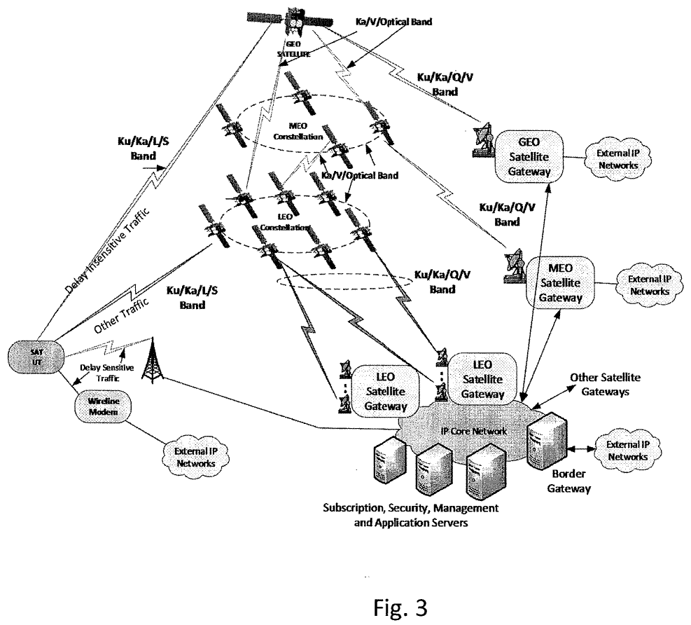

FIG. 3 illustrates a hybrid communication architecture for a satellite communication system, in accordance with various embodiments. According to the illustrated embodiment, a LEO satellite and MEO mega constellation is used to augment the terrestrial and GEO systems, in accordance with various embodiments. The system includes an exemplary UT (or sat UT, terminal, sat terminal) that includes multiple modems to facilitate simultaneous communication with multiple radio access technologies (RATs) namely satellites, terrestrial and wireline. According to the illustrated embodiment, user links may operate on Ku and/or Ka bands for high-throughput scenarios. In order to provide higher availability against severe rain fade and to allow operation with smaller end-user devices, however, the satellite and user terminals can be configured to support both L- and S-band operation. FIG. 3 also shows different satellite gateways connected to LEO, MEO and GEO constellations

The IP core network incorporates some of the functionality of 5G network. Further, the border gateway is configured to provide user plane function (UPF) of the 5G core network (5G core). The system further includes a subscription server configured to provide functionality similar to the Unified Data Management (UDM) of the 5G core; a management server configured to provide functionality similar to the Access and Mobility Management Function (AMF) and Session Management Function (SMF); and a security server configured to provide functionality similar to the Authentication Server Function (AUSF).

According to the illustrated embodiment, the gateways are configured for communicating directly with their respective satellite constellations. It should be noted, however, that other embodiments can provide gateways configured to connect with each other using 5G Xn interface in order to reduce the inter-gateway handover time. For a UT that is communicating with the LEO or MEO satellites, even though the UT location is fixed, there will be frequent handovers because of the movement of the beams and satellites. According to various embodiments, ISLs are provided to facilitate intra-constellation communication between satellites in the LEO and MEO constellations. Additionally, ISLs are provided to facilitate inter-constellation communication between different LEO orbits (or constellations) as well as MEO and GEO orbits (or constellations). Similarly, ISLs are provided to facilitate inter-constellation communication between satellites with different MEO orbits as well as satellites in GEO orbits. According to such embodiments, the intra-constellation and inter-constellation links established by the ISLs can enhance the security and reduce the delays since communication between UTs handled by different gateways can be routed via cross-link instead of land-line connection between gateways. Such features differ from conventional satellite communication systems which only provide cross-links between satellites within a particular constellation.

As shown in FIG. 3, the hybrid communication system allows the UT to independently select the most appropriate system for sending and receiving application data. For example, a UT can send delay sensitive data via terrestrial system, if available, and send other data to the satellite system. According to various embodiments, digital transponders, on-board switching, and inter-constellation links can be selectively utilized across GEO, MEO, and LEO orbits optimize throughput, delivery, and security.

The hybrid communication architecture allows a smooth handover based on the most suitable link for a UT. For example, a UT which is initially communicating on the 5G terrestrial system can switch to the 5G satellite system to avoid interruptions when the terrestrial link degrades or becomes unavailable. Similarly, the UT that initially only has access to satellite links can re-route its delay sensitive traffic to the terrestrial system when it becomes available.

Data Forwarding Among Satellites

Certain scenarios require communication between two or more UTs operating on different satellite orbits and gateways. In order to allow data transfer between these UTs, the traffic might be carried between two or more gateways on a terrestrial land line network such as the internet. As the traffic travels over the land line network, various points may be vulnerable to interception by unwanted parties. According to at least one embodiment, the inter-constellation links provided by the ISLs make possible that the data forwarding is executed between satellite on different orbits. Hence, the potential data interception by an unwanted party can be eliminated. Furthermore, for the case of legal interception, the authorities do not want the data to reach unintended destinations. Hence by using ISL and/or cross-link among satellites, the data does not have to be routed between gateways over land line networks, thereby eliminating the risk of potential third party interception.

According to various embodiments, the terminal is configured to access various types of technologies, and carry traffic based among the best available path. The best available path can be selected based on various factors including, for example, quality of service, delay sensitivity, type of traffic, user subscription plan, etc. The terminal is configured to utilize various types of RATs such as satellite, cellular networks, wired networks, etc. Furthermore, the terminal is capable of utilizing some or all of the different RATs simultaneously. For example, a terminal may simultaneously utilize a wired network or cellular network to carry delay sensitive traffic, while also utilizing one or more types of satellite networks to carry delay insensitive traffic. According to such features, the terminal is capable of effectively using all the different RATs to optimize bandwidth usage and provide users with the best quality of service. The terminal is further capable of dynamically assessing the best RAT for each type of traffic based on the service currently available. If a terminal travels to a remote area where cellular and landline service are not available, for example, then satellite networks would be utilized. In such cases, delay sensitive traffic may be routed over a LEO satellite constellation, while delay insensitive traffic is routed through a GEO satellite constellation.

According to an embodiment, traffic sensitivity can be assigned based on socket information associated with the packet flow. For example, the terminal can examine header information contained in packets to be transmitted in order to identify the port number associated with the traffic. Certain ports are utilized in IP networks for carrying specific types of applications. Such designations are typically well known. For example, port number 80 is generally used for web browser traffic, port 21 is use for FTP traffic, port number 53 is used for DNS traffic, etc. Thus, the terminal can identify the port number, and assign a level for traffic sensitivity based on the type of application commonly associated with the port.

According to another embodiment, the terminal can examine the type of service (TOS) field in the packet header to determine the Differentiated Services Code Point (DSCP) value which designates the type of traffic being carried by the packet. For example, packets carrying voice traffic will contain information specifying expedited forwarding. Packets carrying streaming media would contain information specifying assured forwarding, class IV. Packets carrying web browser traffic would contain information specifying assured forwarding, class III.

Protocol Architecture

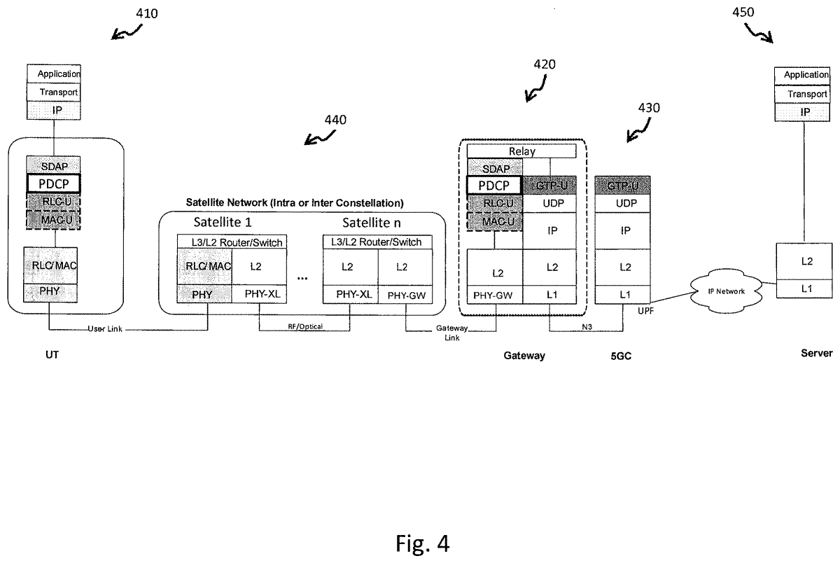

FIG. 4 illustrates protocol stacks for components used in a hybrid communication system, in accordance to one or more embodiments. As illustrated in FIG. 4, the system includes a UT protocol stack 410, a gateway protocol stack 420, a 5G core protocol stack 430, a satellite network protocol stack 440, and a server protocol stack 450. While only two satellites are shown as part of the satellite network protocol stack 420, it should be noted that such representation is only made for illustration purposes and not intended to be limiting. Rather, each satellite within the different constellations (LEO, MEO, GEO) contains such an architecture in order to facilitate intra-constellation communication as well as inter-constellation communication.

According to the illustrated embodiment, the terminal protocol stack 410 contains, in part, the following layers: PHY, RLC/MAC, MAC-U, RLC-U, PDCP, and SDAP. Furthermore, the functions associated with conventional RLC layers are split between the RLC-U and RLC/MAC layers, while functions associated with conventional MAC layers are split between the MAC-U and RLC/MAC layers. The gateway protocol stack 420 contains, in part, the following layers: PHY, L2, MAC-U, RLC-U, PDCP, SDAP, and GTP-U. According to the illustrated embodiment, the MAC-U, RLC-U layers function as peer entities to the corresponding layers of the terminal protocol stack 410. The 5G core protocol stack 430 includes conventional layers plus a GTP-U layer which corresponds to peer entity to that of the gateway protocol stack 420. The server protocol stack 450 contains conventional OSI layers.

According to the illustrated embodiment, the satellite network protocol stack 440 includes the following layers for each satellite: PHY, RLC/MAC, and L3/L2 router/switch. In order to communicate with the terminal, each satellite includes a corresponding peer entity for the PHY and RLC/MAC layers. According to various embodiments, each satellite is capable of intra-constellation or inter-constellation communication over an RF/optical link using, for example, digitized transmission. Thus, the PHY layer of each satellite is capable of also functioning as a peer entity to the PHY layer of other satellites. More particularly, signals between the different satellites are digitized and carried within a constellation and across constellations. The PHY layer of each satellite is also capable of functioning as a peer entity to the gateway's PHY layer in order to transmit and receive RF signals over the gateway link. The L3/L2 layer performs various functions including forwarding and routing of packets across intra-constellation and inter constellation links.

According to the embodiment illustrated in FIG. 4, the terminal communicates with the satellite network via a user link, while the gateway communicates with the satellite network via a gateway link. While a single link is illustrated between the gateway and the satellite network it should be appreciated that various embodiments can incorporate a gateway configured to independently communicate with each satellite constellation. Accordingly, the gateway would include a user link to the LEO constellation, a user link to the MEO constellation, and a user link to the GEO constellation. Similarly, a different gateway may be provided to communicate with each constellation of the satellite network. Accordingly, one or more gateways can be provided for communicating with the LEO satellites over the gateway links, one or more gateways can be provided for communicating with the MEO satellites over corresponding gateway links, and one or more gateways can be provided for communicating with the GEO satellites using one or more gateway links. Furthermore, the gateway can be interconnected with the 5G core network in order to exchange information using, for example, an N3 interface. The 5G core network further transmits and receives information to and from the server using an IP network. Depending on the specific implementation, the IP network can be a private network or a public network such as the Internet.

As previously discussed, digital links are utilized for carrying traffic between satellites. This is done in order to minimize the bandwidth utilized for transmitting the signals. For example, a terminal transmitting at a 2 GHz frequency would utilize a 64 Gbps bandwidth. More particularly, the 2 GHz signal would need to be digitized with at least twice the highest frequency of the signal, thus resulting in about 4 Gsps (Giga samples/sec). If each sample is represented by 16 bits, 64 Gbps is achieved as follows:

2 GHz*2*16 bits/sample=64 Gbps

Utilizing such high-bandwidth for cross link traffic between the satellites can unnecessarily degrade system performance particularly when the actual information to be transmitted may only be in the order of 10 Mbps.

According to one or more embodiments, signals that are to be transmitted between satellites are demodulated and decoded at the satellite in direct contact with the terminal or gateway. The satellite downconverts the signal from 2 GHz to a 10 Mbps information bearing signal. The signal is subsequently transmitted to one or more satellites using only 10 Mbps over the digital satellite links. The final satellite receives the digital signal and modulates it to the appropriate band for transmitting to the corresponding gateway or terminal. As previously discussed, each satellite constellation is serviced by respective gateways. Such gateways may establish different modulation and coding schemes for communicating with the satellite and supported terminals. Thus, the final satellite would modulate the signal in accordance with the parameters specified by the appropriate gateway.

The ability to transmit information between different satellites can have various advantages depending on the specific application. For example, certain customers may require packets to arrive only at a designated trusted gateway in order to avoid or minimize possible points of interception in the ground link. Accordingly, traffic designated to such customers can be routed across the satellite network to the designated gateway regardless of the terminal from which the traffic originates. The total number of gateways utilized by a satellite constellation can also be reduced through the use of satellite links in order to account for changing gateway visibility resulting from movement of the satellites.

As previously discussed, the protocol stack of each satellite includes a MAC layer (RLC/MAC) that functions as a peer entity to the RLC/MAC layer of the terminal. When a terminal submits a request for resource allocation, the peer MAC layer in the satellite is fully aware of its available resources. Thus, the MAC layer in the satellite can immediately determine frequency and time slots to be used for communicating with the satellite. This information can subsequently be supplied to the terminal without delay. Such features advantageously eliminate the need to forward the request for resource allocation all the way to the gateway. Furthermore, if the initial satellite moves out of visibility from the terminal, the gateway may not have resource information for the next satellite. Such a situation would result in additional delays, because the gateway would have to obtain resource information from the new satellite. Depending on the specific transaction required by the terminal, additional delays can be incurred from acknowledgments required between TCP transactions. The RLC/MAC layer of the satellite advantageously bypasses such delays by supplying resource information directly to the terminal.

According to the illustrated embodiment, the satellites also include a peer RLC layer to the terminal. Such a feature allows segmentation and reassembly of IP packets to be performed at the satellite. For example, an IP packet may be 1500 bytes in length, and must be transmitted over a PHY layer that may only handle 75 bytes. The RLC layer would, therefore, segment the IP packet into 20 segments of 75 bytes. In situations where multiple satellites move out of visibility from the terminal during a transmission, each satellite would be capable of reconstructing the received packets for transmission to the gateway. As can be appreciated, protocol stack functions that depend, in part, on satellite movement are incorporated into the protocol stack of each satellite.

According to one or more embodiments, the terminal protocol stack 410 includes an RLC-U layer which performs in part, re-transmission operations. Such operations can be required, for example, for guaranteed delivery services that may be part of automatic repeat requests (ARQ). When a 1500 byte IP packet is segmented, and 20 segments of 75 bytes are transmitted, there is a possibility that one or more segments may not arrive at the destination. The RLC-U layer can identify the missing segment or segments, and request retransmission of only those segments instead of the entire IP packet.

The terminal protocol stack 410 includes a MAC-U layer with a peer entity at the gateway protocol stack 420. The MAC-U layer is responsible for providing link adaptation by determining the modulation and coding scheme to be used for transmitting signals. This can be based, in part, on a channel conditions being experienced by the terminal. According to an embodiment, the channel can be observed for predetermined time. And signal quality reports are sent from the terminal directly to the gateway. This allows the gateway to determine channel conditions for the terminal regardless of the satellite being used to establish the connection. Accordingly, complexities associated with satellites moving in and out of visibility of the terminal during transmissions can be avoided. The MAC-U layer at the gateway subsequently utilizes the signal quality reports to make appropriate modulation and coding decisions. As can be appreciated, protocol stack functions that do not depend on satellite movement are incorporated into the protocol stack of the gateway.

According to one or more embodiments, the 5G core is configured to implement all subscription, security, mobility, and session management decisions. The subscriptions can correspond, for example, to the type of software and services that a particular terminal is authorized to access. The 5G core further manages the type of encryption being used (e.g., 128 bit, 256 bit, etc.), handshake, key exchange procedures, etc. that will be used during different sessions. The 5G core also manages terminal mobility in order to properly track terminals moving from one location to another. When an incoming session must be established, the tracking implemented by the 5G core can assist in routing the session to the terminal in a more efficient a manner. When a terminal establishes a particular session and requests allocation of various resources, the 5G core can communicate with a subscription server located, for example, at a central entity such as the NMS in order to determine if the user may access such resources. The determination can be based, in part, on whether or not the user has paid a particular subscription fee to access the resource. According to various embodiments, the 5G core can also determine the most efficient paths for routing different types of traffic from the terminal based on the type of RAT available to the terminal. Thus, regardless of whether the terminal moves between terrestrial, LEO, MEO, or GEO networks, the best path for reaching the terminal can be determined because a common 5G core is utilized.

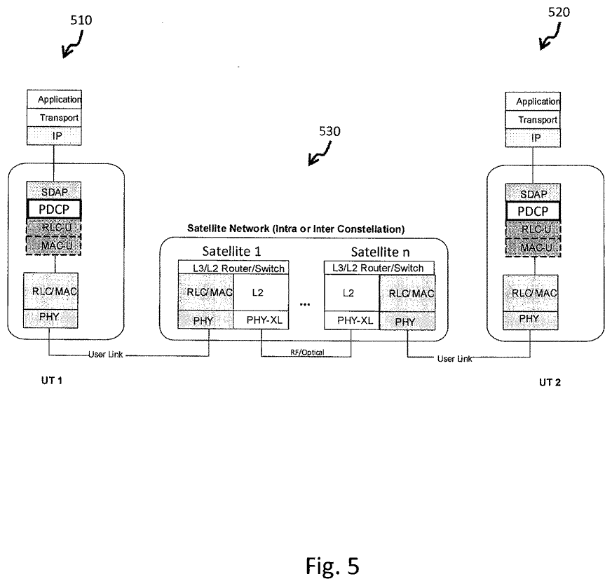

FIG. 5 is a diagram of a protocol stack for a hybrid communication system, in accordance to an additional embodiment. The system advantageously enables establishment of direct terminal to terminal communication links. According to the illustrated embodiment, the system includes a first UT protocol stack 510, a second UT protocol stack 520, and a satellite network protocol stack 530 configured in the same manner previously described with respect to FIG. 4.

In order to establish a direct communication link between the first UT and the second UT, a connection is first established between the first UT and a satellite in the satellite network. According to various embodiments, the terminal can establish the connection with a satellite in any of the available constellations (e.g., LEO, MEO, GEO). Packets from the first UT can be routed across multiple intra-constellation and inter-constellation satellites using RF/optical links. Depending on the destination address of the packets, each satellite can utilize routing information (e.g., routing tables) available to its L3/L2 router/switch layer.

According to the illustrated embodiment, the connection does not terminate at a gateway in the manner previously described with respect to FIG. 4. Rather, a second UT is designated for receiving the packets from the first UT. As previously discussed, the second UT includes a protocol stack 520 identical to the protocol stack 510 of the first terminal. Furthermore, the final satellite routes the traffic through the peer RLC/MAC and PHY layers for transmission to the second UT. Such a configuration allows traffic between the first UT and the second UT to be routed exclusively over the satellite links without assistance from any gateways. Accordingly, any satellite (LEO, MEO, GEO) can be used to deliver packets to the second UT.

According to an embodiment, each terminal can specify the type of connection being initiated with the satellite. Such information can be used for routing the packets so that the final satellite knows whether the packets should be transmitted to another terminal or a gateway. For example, the first terminal can insert information in the header of one or more packets to specify that the destination should be a second terminal. According to at least one embodiment, specific ports may be designated for terminal to terminal communication. Thus, the first terminal may simply specify the designated port number when transmitting packets to the first satellite. When the packets arrive at the final satellite, the header is examined to determine whether the packet should be transmitted to the gateway or another terminal. Since the first terminal specified the port number designating terminal to terminal communication, the final satellite would transmit the packets over a user link to the second terminal, as identified by the destination address in the packet headers.

Mobility in Mega Constellation

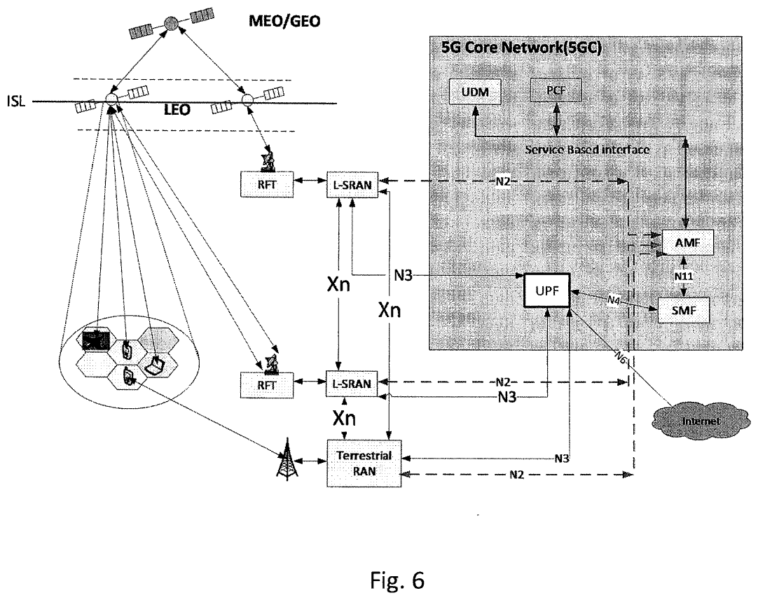

FIG. 6 illustrates a terrestrial/LEO/MEO/GEO system topology with 5G core network, in accordance with one or more embodiments. There are several different types of terminals used in this system. There are terminals that only has one radio access technology (as illustrated in FIG. 1), and there are terminals that have multiple radio access technologies called Multi-Mode Terminal (MM Terminal). As used herein, the term UT can correspond to either conventional or MM terminals, depending on the specific embodiment being described or illustrated. Furthermore, the satellite systems described in the disclosed embodiments can simultaneously support single and multiple radio access technology terminals.

According to various embodiments, satellite mobility and constellation dynamics can be hidden from core network elements. When a terminal establishes a session with a LEO MEO satellite, there is a possibility that multiple handoffs will occur because the satellites in these constellations are always moving. Depending on the specific implementation, it is possible for handoffs to occur at regular intervals ranging from 3 to 30 seconds. The handoffs can occur, for example, when a terminal initiates a communication session with a first satellite, which subsequently goes out of view during the session. The handoff is performed to transfer the session from the first satellite to a second satellite. The terminal now continues the communication session with second satellite. As time passes, it may be necessary to perform another handoff if the communication session continues. Similarly, handoffs may be performed when the terminal initiates the communication session while located within a first beam of a particular satellite. As the satellite moves, the terminal may become positioned within a different beam of the satellite. In such cases, a handoff may occur from the first beam to the second beam in order to continue the communication session.

According to various embodiments, such dynamics are hidden from the core network by providing protocol stacks in the gateway such that signals transmitted from a terminal during a session always terminate at the gateway regardless of the specific path used to route the signals between different satellites. Such handoffs further include beam handoffs within a particular satellite, handoffs between different RATs, intra-constellation handoffs, as well as inter-constellation handoffs. Thus, from the viewpoint of the 5G core, a continuous session is established with the gateway regardless of the handoffs occurring to transmit the signal. Packets received by the 5G core from external sources are supplied to the gateway in a normal fashion. The gateway subsequently determines which satellite currently has visibility to the terminal and routes the packets to the satellite so that they are received by the terminal.

According to at least one embodiment, the gateway can further determine whether or not a satellite currently visible to the terminal will have moved beyond visibility by the time the packets are scheduled to arrive at the terminal. The gateway can therefore determine the next satellite that will have visibility to the terminal and route packets to that satellite. If the information being transmitted to the terminal is sufficiently large, the gateway can further determine the sequence for transmitting a first portion of the packets to a 1st satellite, a second portion of the packets to a 2nd satellite, a third portion of the packets to a 3rd satellite, etc., based on visibility of each satellite to the terminal with respect to time. Accordingly, all packets will be received by the terminal despite multiple handoffs due to satellite visibility to the terminal. As further illustrated in FIG. 6, handoffs that occur to a terrestrial network arrive at a terrestrial RFT and prior to being supplied to the 5G core network.

According to an embodiment, when the gateway receives packets destined for a particular terminal, it adds a header to specify that the packet should reach a particular destination satellite. The destination satellite is the satellite which will ultimately transmit the packet to the terminal. When a 2nd satellite comes into view of the terminal, the gateway modifies the header of subsequent packets to identify the 2nd satellite so that the remaining packets are delivered to the terminal. According to various embodiments, the gateway contains information pertaining to the exact location of all terminals (i.e., latitude/longitude) within its assigned constellation. Various implementations can further allow gateways associated with different constellations to exchange information pertaining to the location of terminals. The gateway also contains information pertaining to which satellite in the constellation is covering each part of the total coverage area. Depending on the specific implementation, the constellation may be designed to cover specific regions such as countries, continents, etc., or the constellation may be designed to cover the entire earth. Given a particular terminal, the gateway contains sufficient information to identify which satellite is visible at any instant in time as well as which beam will overlap the location of the terminal. Furthermore, the gateway is configured to transmit control signals to the terminal in order to indicate when the terminal should switch from one satellite to another.

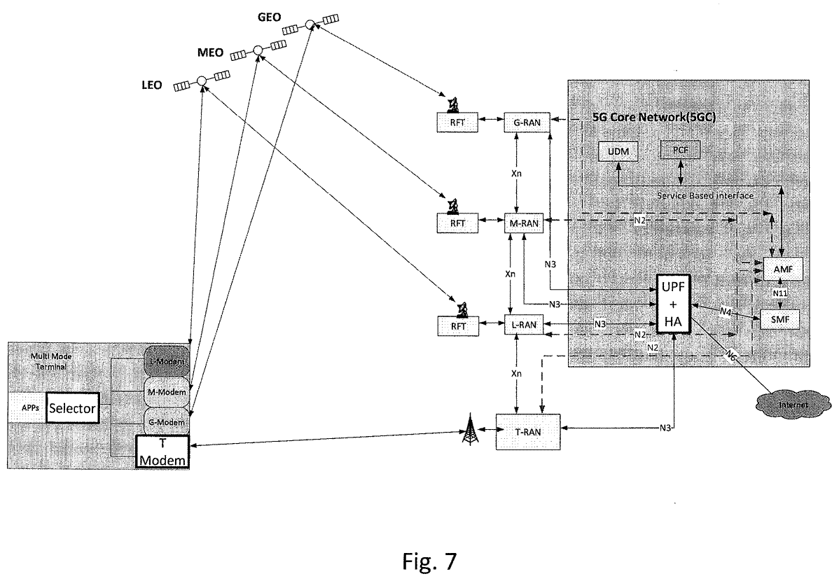

FIG. 7 illustrates network topology for a terminal that has multiple radio access capabilities. The UPF is also equipped as a Home Agent (HA) that will bind all IP addresses assigned to this terminal. This type of terminal will be able to route the application data into a radio access based on its characteristic such as delay. According to at least one embodiment, each RAN includes an Xn interface in order to facilitate connections to other RANs.

According to the illustrated embodiment, the terminal includes multiple physical layer interfaces which allow communication with different RATs. For example, the terminal includes an L-modem for communicating with LEO satellites, and M-modem for communicating with MEO satellites, a G-modem for communicating with GEO satellites, and a T-modem for communicating with a terrestrial networks. Depending on the specific implementation, the T-modem can be configured to communicate directly with landline networks, cellular networks, or both. Furthermore, the terminal is capable of simultaneously communicating with any combination of RATs. Thus, the terminal can communicate with any combination of satellite and terrestrial network simultaneously. The terminal further includes a selector unit which selects the particular modem or modems to be used for communication. Signals to and from the different modem are exchanged with either the gateway corresponding to a particular satellite constellation or a terrestrial connection point such as an edge router, eNodeB, etc. The RAN associated with each RAT subsequently provides the packets to the 5G core network.

Terminal Mobility

With the LEO or MEO satellite constellations, the beams on the earth surface are moving constantly as a result of satellite motion. Therefore, the UT will be connected to the RAN via different beams and satellites. To maintain the UT connectivity, the RAN can be configured to provide the necessary information for the UT to perform beam and satellite handover. The 5G core also needs to know the UT location for paging purposes. According to an embodiment, the UT can be configured to update its location by sending the Registration Area Update (RAU) to the 5G core. Table 1 shows the UT mobility depending on the RAT of the UT.

TABLE 1
UT mobility for various satellite orbits.
UT Mobility

| | | Beam/Satellite | SBSS/RAN | | |
|---|---|---|---|---|---|
| UT Type | RAT | HO | HO | P-RAU | M-RAU |
| Static UT | Terrestrial | N/A | Y | Y | N |
| | GEO | N | N | Y | N |
| | MEO | Y | Y | Y | N |
| | LEO | Y | Y | Y | N |
| Vehicular/ | Terrestrial | N/A | Y | Y | Y |
| Aero UT | GEO | Y | Y | Y | Y |
| | MEO | Y | Y | Y | Y |
| | LEO | Y | Y | Y | Y |

It should be noted that there are two type of RAUs: periodic RAU (P-RAU) and movement based RAU (M-RAU). The terms P-RAU and M-RAU are also simply referred to as RAU. Furthermore, RAU and Tracking Area Update (TAU) are used interchangeably.

According to the illustrated embodiment, the UT can send and receive the traffic via multiple radio access technologies depending on the characteristic of the traffic. The traffic that goes via terrestrial and GEO will not be experiencing a periodic handover compared to the traffic that goes via LEO or MEO satellite. Hence each radio access at the UT must handle the mobility individually.

From the 5G core point of view, each UT is in one of the two connection management (CM) states: CM-IDLE or CM-Connected. In CM-IDLE state, the UT has no non-access stratum (NAS) signaling connection with AMF. From the RAN point of view, a UT is in one of the three Radio Resource Control (RRC) states: RRC-Idle, RRC-Inactive and RRC-Active. When UT is in CM-IDLE state, UT is also in RRC-Idle state. In this state, the UT performs cell (or beam) selection and PLMN selection. When there is data coming to the UT, the 5G core will page the UT. UT needs to perform Service request when it needs to sends a data. In CM-Connected state, UT can be in RRC-Inactive state or in RRC-Connected state. When UT is in RRC-Inactive state, paging for incoming data is performed by the RAN.

The UT mobility in 5G satellite system is similar to the UT mobility in 5G terrestrial system: 1) Mobility when the UT is in CM-Idle state/RRC-Idle state: In this state, the UT is registered to the 5G core, but it does not have active data traffic. From the 5G core point of view, the UT is in CM-Idle state. The UT performs beam selection and reselection. The UT should have enough information to camp on the proper beam and listen to the common control channel for system information. The UT can subsequently be paged by the 5G core when data is sent to the UT. Considering a UT will have connections with 5G core via multiple RATs, various embodiments provide an efficient 5G core paging scheme capable of sending the paging signal to the UT via only the most possible RAT. In this state, the AMF can page via terrestrial access, if available, even if the incoming data is for non-terrestrial access. If terrestrial access is not available, AMF will page the UT via the access that has the shortest delay.

2) Mobility when the UT is in CM-Connected state/RRC-Inactive state: In this state, the UT is registered to the 5G core, but it does not have active data traffic. However, the UT location is known to the RAN at the beam level. From the 5G core point of view, the UT is in CM-Connected state. The 5G core will not page the UT when data is sent to the UT. Paging will be the responsibility of the RAN. This state is beneficial to satellite system since at this state the RAN keeps the UT context. Hence it reduces the number of beams where the paging occurs and also reduces the re-establishment of the flow to the 5G core. For multi-RAT UT, the RAN will page only for the intended RAT.

3) Mobility when the UT is in CM-Connected state/RRC-Active state: In this state, the UT has active data traffic. The UT is either moving and requires handover or the UT is static. However, beam/satellite movement results in satellite, beam, and gateway handovers.

Handover

UTs in the mega satellite constellations will be experiencing different types of handovers:
Beam to Beam Handover (B2BHO)
Satellite to Satellite Handover (S2SHO)
Gateway to Gateway Handover (G2GHO)
Inter-RAT Handover (R2RHO)

For the LEO constellation, the B2BHO can happen in several seconds and S2SHO can happen in several minutes. To minimize session disruptions caused by frequent handovers, the gateway calculates the time trajectory of the subsequent handovers for each UT. The handover trajectory can be calculated accurately since the satellites motions, and the beams motions, are deterministic. The handover method for the LEO constellation is also applicable to the MEO constellation.

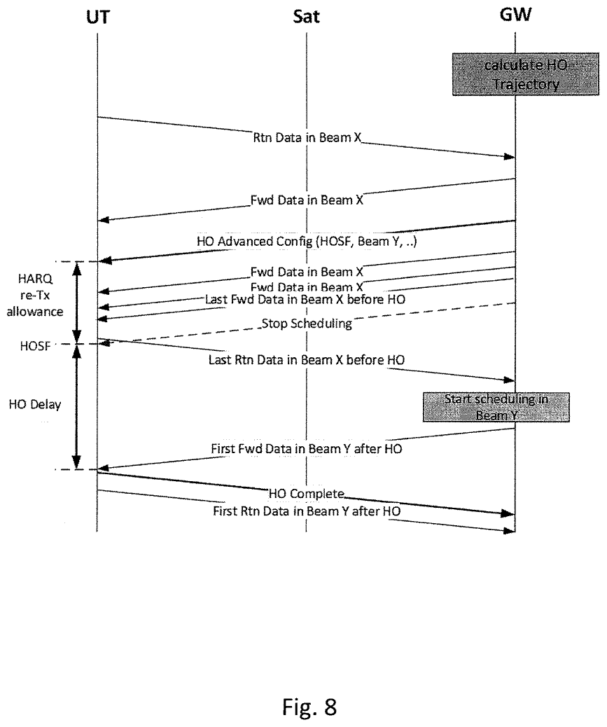

FIG. 8 is a diagram illustrating call flow for B2BHO. The GW/RAN, based on the HO trajectories, knows when the UT will perform a handover from beam X to beam Y in the form of handover subframe (HOSF) time. Hence a few milliseconds before the HOSF time, the GW provides the UT with the parameters for the B2BHO such has the HOSF, beam number, etc. the GW knows when to send the last data on the forward link so that this data will arrive at the UT just before the HOSF time. The UT also knows when to send the last data on the return link just before the HOSF time.

Paging

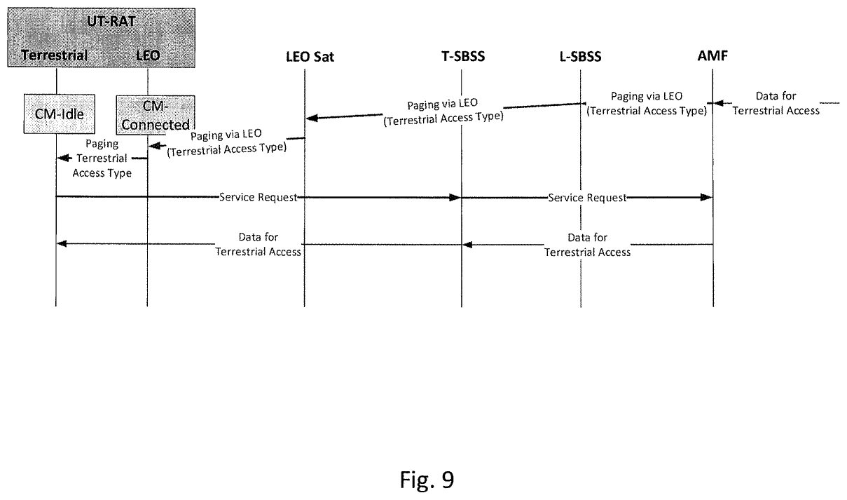

FIG. 9 is a diagram illustrating a paging process for terrestrial access via LEO access. Since LEO/MEO beams are constantly moving, beam based paging cannot be applied. Rather, various embodiments provide for paging based on the UT location, i.e. GPS location, which will be mapped to the LEO or MEO beams at the time the paging signal needs to be sent to the UT.

During registration, each UT reports its location to the RAN. The RAN then provides the AMF with the Tracking Area (TA) Identifier of the UT based on the reported UT location. AMF then sends the TA list (TAL) to the UT in which the UT does not need to report its location if the UT is still inside the boundary of the TAL.

For 5G core paging, AMF sends paging signal via any access, i.e. RAT, that is in CM-connected mode even though the paging is for different access(s). For example, for a UT in CM-Idle mode in terrestrial access and in CM-Connected mode in LEO access, paging for terrestrial access will be delivered via LEO access containing the terrestrial access type. The UT sends a Service Request via terrestrial access as a response to the 5G core paging.

If a UT is in CM-Idle mode in all accesses, the 5G core paging will delivered via terrestrial access if available. If terrestrial access is not available, the paging will be delivered via LEO or MEO or GEO access in the order from lowest to highest delay whichever is available. For RAN paging, either from M-RAN or L-RAN, the RAN will page the UT in the beams that cover the UT location at the time of the paging signal is sent.

Routing Management

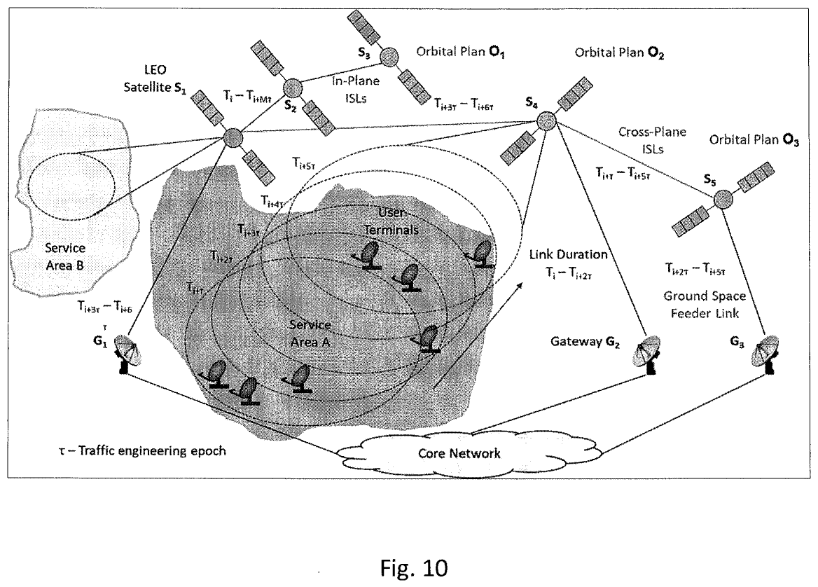

FIG. 10 illustrates traffic Estimation and route determination timelines for a mega constellation satellite ground network, in accordance with various embodiments. According to at least one embodiment, rather than exchanging routing tables between all satellites in the satellite network, a central entity is designated for collecting all routing information and tables. Each satellite can be configured to transmit its current routing information to the central entity at predetermined time intervals. The central entity can be part of the 5G core network, the NMS, or a designated gateway capable of relaying information to all gateways in the satellite network. The central entity analyzes routing and traffic information across all satellites in the satellite network in order to determine the best routes in the system. The central entity subsequently transmits updated routing information to each satellite. Such routing information can be transmitted, for example, at predetermined times and/or specific intervals. The intervals may be chronological or based on traffic load. Each satellite utilizes the received routing information for routing packets to other satellites in the satellite network. Since the central entity does a global analysis of all routing information, the routing tables received by each satellite will include the most efficient routes for both intra-constellation as well as inter-constellation routes for the packet.

The traffic routing can be based, for example, on the SDN OpenFlow (OF)-based link state measurements, centralized traffic route determination to address continuous ISL and Ground-Space Link (GSL) setup and teardown, and standardized OF-based configuration of hardware. Time-based traffic routing plans can be used for configuring routing tables in the satellite payloads and ground gateways to minimize the impact of continuous rerouting as the network topology changes due to the LEO/MEO satellite movement. Optimal traffic engineering, even for dynamically changing traffic loads and network topology, can be performed to efficiently route traffic over various nodes and links supporting differentiated services. A finer-grained optimization scheme includes individual QoS specifications (e.g., shorter delay, or assured delivery) for various traffic flow types. Route determination at SDN controller uses a linear algebraic traffic transport model with the following features: time and location based estimates for individual traffic classes for various service areas, identification of satellites for covering a service area for specific time durations, and proactive time-based route table updates for optimal traffic routing.

SDN decouples control and data planes, and a centralized SDN orchestration function directly controls the switching fabric of all network nodes. The SDN controller optimizes network performance (e.g., dynamic traffic routing for resource utilization) based on link and node status information sent by each node to the controller. LEO constellations can include a variety of orbits at various altitudes, including polar orbits, each of which containing multiple satellites. A typical satellite has can include antennas for ISLs for in-plane and cross-plane connectivity. FIG. 10 shows three such orbital planes, with focus on a service area covered by a single satellite S_2 that connects the varying number of UTs as it moves over the service area. Since the satellites within an orbital plane are relatively stationary with respect to each other, such in-plane ISLs are of longer duration compared to the cross-plane ISLs.

The aggregate traffic associated with the UTs and transported by S_4 changes with time as shown for times T_(i+τ), T_(i+2τ), through T_(i+5τ). Here τ represents a traffic engineering epoch, with a numerical value that balances the computing load at the SDN controller with sufficient granularity to correctly estimate the traffic demands across the moving coverage area of a satellite. Because of the satellite S_4 movement, ISLs and GSLs are established for specific (and deterministic) time durations and connectivity between the service area A and the core network via the satellites, ISLs, and GSLs changes. For this simple example such changing network connectivity is summarized in table 2 (below).

TABLE 2

| Duration - | Path between | Traffic Estimates | Use of ISL |
|---|---|---|---|
| Multiple | Service UTs for | for Service Area | (this example |
| TE | Area A and the Core | A Transported by | uses Cross |
| Epochs | Network | Satellite S₄ | Plane ISLs) |
| T_{i+τ} to T_{i+2τ} | Satellite S₄ and | Min = 2, | No ISL needed |
| | Gateway G₂ | Max = 4, | |
| | | Avg = 3 | |
| T_{i+2τ} to T_{i+3τ} | Satellite S₄, Cross | Min = 3, | ISL needed for |
| | Plane ISL, Satellite S₅, | Max = 4, | continuous |
| | and Gateway G₃ | Avg = 3.5 | connectivity |
| T_{i+3τ} to T_{i+5τ} | Satellite S₄, Cross | Min = 3, | ISL needed for |
| | Plane ISL, Satellite S₁, | Max = 3, | continuous |
| | and Gateway G₁ | Avg = 3 | connectivity |

Over the five traffic engineering epochs described above, traffic routing over the satellite-ground network is distinct for three routing durations (named routing eras): T_{i+τ}, to T_{i+2τ}, to T_{i+3τ}, and T_{i+5τ} to T_{i+5τ} and would have respective distinct routing tables. Since the satellites within an orbital plane are relatively stationary with respect to each other, such in-plane ISLs are almost permanent, compared to a bit more dynamic cross-plane ISLs (across the adjacent planes). Without failures or power conservation considerations, these ISLs are likely to be established for hours at a time within a constellation. A gateway, even with high-gain antenna and ample transmit power, can maintain a feeder GSL only for a few minutes. The duration of each such GSL link depends on the changing location of the satellites and fixed locations of the gateways. With a typical mega constellation involving thousands of satellites and 10 s to 100 s of gateways, it is likely that the smallest routing era, corresponding to no link change for the entire duration, could last only a few seconds. Traffic engineering and routing in such dynamic networks are governed by the changes in the network topology instead of temporal changes in traffic demands. However, both of these factors need to be included in a comprehensive route determinations for each such routing era.

The overall traffic estimation and route determination is more tractable by using a sequence of two-step processes. The first step uses the orbital dynamics of the satellites, location of the gateways, services areas and plans, and location of the terminals to estimate the (time dependent) traffic matrix and topology of the network. Traffic across epochs belonging to a routing era can be averaged or, for a more conservative estimate, the maximum value across the epochs can be selected for the corresponding routing era. The second step of the routing process actually determines the routing tables for the space and ground nodes within the network topology and edge connectivity which are now static during the entire routing era.

Traffic estimation and capacity model for dynamic RF links

Traffic estimation requires the time-varying coverage of service areas with specific satellites. For routing purposes, a LEO trajectory in its orbital plane can be accurately determined using the Keplerian dynamics. A Geographical Information System (GIS) can used to process the following: the UT locations, UT service profiles, gateway locations, and gateway capacity (total number of GSL beams available for potential satellite contacts). The correlated position and traffic data is used to estimate the expected traffic demands against the moving satellite coverage area and also to determine the times at which the various GSLs (and occasionally ISLs) need to be setup and/or torn down. This information results in a comprehensive dataset, similar to the above table, comprising satellite-gateway contact plans, UT-satellite contact plans, and ISL setup/teardown plans for all service areas.

Traffic estimation uses a specific gateway (often the nearest) anchoring (a subset of) the UTs located in a service area, which in the above example is gateway G_2. This UT-gateway anchoring association provides the traffic pairs of sources and destinations by utilizing the service plans (which include uplink and downlink data rates and SLAs for best effort or assured services for each UT) for the aggregate of user terminals anchored by a gateway. The location of the satellites and their coverage areas change so even for stationary UTs with static aggregate traffic demands, traffic transport over the space-ground network topology varies with time. However, the traffic demand itself may have temporal variation (e.g., diurnal) which is included in the first step that generates a specific traffic matrix for each routing era. Each such routing era is of duration from a few seconds to minutes, and gets its own routing table for route determination.

The routing model can include ISLs, GSLs and terrestrial gateways, each equipped with multiple antennas to concurrently provide feeder links to multiple LEO satellites visible from the gateway location. The link capacity is dependent on the current environmental conditions that create variability in the instantaneous network capacity for transporting traffic from the ingress to the egress nodes. The capacity of a link depends on the power received by a transceiver over free space that allows the use of spectrally efficient modulation and coding schemes for data transmission. Aperture size of the transmitting and receiving antennas increase the channel gain, while path loss, interference, and atmospheric attenuation decrease the received power because of absorption, (scintillation for optical part of the spectrum) and scattering effects. Analytical expressions can be determined to quantify spectral efficiency of a selected modulation and coding scheme and a target BER. Spectral efficiency multiplied by available bandwidth can then provide the capacity of the link in units of Mbps. The waveform can be designed to be adaptive, allowing a link controller to select a specific combination of coding, modulation, and transmit power P_T to deal with atmospheric attenuation, pointing losses, and/or ambient noise. Thus, the instantaneous capacity of a link is a function of time and ranges from a maximum (under the ideal environmental condition, highest transmit power, highest modulation scheme, and least robust FEC) to zero.

According to an embodiment, a Satellite Ground Layer (SGL) is introduced in the protocol stack to implement packet routing across the transport network comprising the satellites and the gateways. An SGL label is added to each packet entering the network, and it includes the following fields: source address, destination address, QoS, and other protocol support fields. For better interoperability, SGL can be used within the context of existing Ethernet 802.1Q standard which already supports user and provider network distinction, virtual LANs, QoS processing, and congestion control.

Route Determination for a Routing Era

Traditionally, packet routing has used distributed control plane protocols. Open Shortest Path First (OSPF) is the dominant intraorganization protocol that uses Dijkstra's algorithm to determine the shortest (but not necessarily optimal) path between every node-pair using the link state information provided by each node that is flooded in the network. With incremental versions to deal with minor network edge and node changes, distributed OSPF route determination can converge in a few seconds for small networks. However, OSPF is typically configured for slower convergence taking several minutes to avoid route flapping and to increase network stability. Border Gateway Protocol (BGP) is the dominant interorganization (typically connecting Autonomous Systems [ASs]) protocol for sharing routing information and changes resulting due to link or node failures. Though rich in describing various kinds of policies for traffic ingress, egress, and associated priorities, BGP is even slower to converge and not suitable when network topology can change in seconds to minutes. According to the disclosed embodiments, linear programming is used to more accurately determine QoS-based routes, which is possible because of higher performance centralized computing facility available with the SDN approach.

The network layer representation of the system comprises two types of nodes: space nodes, represented by set S, and ground nodes (G), which are connected by ISLs and GSLs forming the set L. A node belongs to I, the set of all ingress nodes, if it has at least one port where external traffic from an external node enters the network [symbol] N, L [symbol] . Similarly, E represents the set of all egress nodes such that N=G∪S and I∪E⊆N. Link lᵢⱼ connects the source node i and the destination node j. Link lᵢⱼ has several attributes and corresponding elements are created in the routing model to characterize its propagation delay δᵢⱼ, capacity cᵢⱼ, and usage uᵢⱼ(q), for traffic class q_{∈}Q, the set of all traffic classes. The propagation delay on a link, chiefly dependent on the physical length of the link, can be considered to be constant during a routing era. The capacity of a link is governed by the environmental conditions and use of a specific mod-cod scheme, while the current usage uᵢⱼ(q) depends on traffic routing decisions made at the nodes to optimize a specific objective.

The purpose of a communication network comprising nodes and links is to carry traffic, described by a traffic matrix for a specific routing era, from the source nodes in I to the destination nodes in E. Traffic of a specific class q_{∈}Q that needs to be transported from node s to node d is represented by T(s, d, q), such that Σ_{q∈Q} T(s, d, q)=T(s, d) and the total traffic T^{Total}=Σ_{se1,d∈E}T(s, d). A specific traffic class between a source-destination pair can be divided into multiple subflows tᵢⱼ (s, d, q) for each link to best utilize the network resources and to optimize a specific performance objective under various constraints as defined below.

$$Flow \text{-} Constraint$$

$${\sum }_{j ϵ N} {t}_{ij} ( s , d , q ) - {\sum }_{j ϵ N} {t}_{ij} ( s , d , q ) = \{ \begin{matrix}T ( s , d , q ) , i = s \\ - T ( s , d , q ) , i = d \\ 0\end{matrix} \\ ∀ i ϵ N , s ϵ I , d ϵ E , {l}_{ij} ϵ L$$

The aggregate traffic Uᵢⱼ=Σ_{q∈Q} uᵢⱼ(q) over a link from node i to node j is constrained because of the link (cᵢⱼ) and node (Cᵢ) capacities as follows:

$$Link Capacity Constraint$$

$${u}_{ij} ( q ) = {\sum }_{s ϵ I , d ϵ E} {t}_{ij} ( s , d , q ) \leq {c}_{ij} ∀ i , j ϵ N , {l}_{ij} ϵ L$$

$$Node Capacity Constraint$$

$${\sum }_{j ϵ N} {\sum }_{q ϵ Q} {u}_{ji} ( q ) + {\sum }_{j ϵ N} {\sum }_{q ϵ Q} {u}_{ij} ( q ) \leq {C}_{i} ∀ i ϵ N , {l}_{ij} ϵ L$$

$$Non \text{-} Negative Constraint$$

$${t}_{ij} ( s , d , q ) \geq 0 , {u}_{ij} ( q ) \geq 0 , {c}_{ij} \geq 0 , {C}_{i} \geq 0 ∀ {l}_{ij} ϵ L s ϵ I , d ϵ E$$

A minimum bound for both capacity and/or usage of a link can also be provided to force a certain amount of traffic to flow on that link.

The network level decision-making problem can be summarized as the determination of the individual source-destination subflows of a specific QoS type, tᵢⱼ (s, d, q) and usage uᵢⱼ(q), corresponding to each link lᵢⱼ∈L in the network, subject to multiple linear algebraic constraints and with a specific objective; for example, reducing the overall cost that is a function of current usage uᵢⱼ(q) of a traffic class q carried over respective links and nodes. The total operational cost depends on link and node (both ingress and egress) unit costs, multiplied with respective usage and aggregated over all QoS types, and nodes as described by the following linear algebraic formulation.

$$Minimize Operational Cost$$

$${\sum }_{i , j ϵ N} {\sum }_{q ϵ Q} γ ( q ) . {u}_{i j} ( q ) + {\sum }_{i ϵ N} ( {\sum }_{j ϵ N} {\sum }_{q ϵ Q} Γ ( q ) . {u}_{j i} ( q ) + {\sum }_{j ϵ N} {\sum }_{q ϵ Q} Γ ( q ) {u}_{i j} ( q ) )$$

Here, γ(q) is the unit cost of transporting traffic class q link over a link, and Γ(q) is the unit cost at a node for processing outgoing or incoming traffic of QoS q. For example, γ(q) can include cost of applying scarce satellite transmit power for ISLs and GSLs.

According to an embodiment, another optimization objective can be to reduce the overall propagation delay where δᵢⱼ is the propagation delay for link lᵢⱼ, and Δ(q) and Δ′(q) are respectively the average ingress and egress queuing delays for traffic of type q for the routing era under consideration.

$$Minimize Propagation Delay$$

$${\sum }_{i , j ϵ N} {\sum }_{q ϵ Q} {δ}_{i j} . {u}_{i j} ( q ) + {\sum }_{i ϵ N} ( {\sum }_{j ϵ N} {\sum }_{q ϵ Q} Δ ( q ) . {u}_{j i} ( q ) + {\sum }_{j ϵ N} {\sum }_{q ϵ Q} {Δ}^{′} ( q ) {u}_{i j} ( q ) )$$

These optimization problems, with a linear algebraic objective function, available link, node capacity bounds, and other linear algebraic constraints, can be transformed into an efficient linear programming representation where several techniques (e.g., SIMPLEX) and software algorithms are widely available for efficient implementation.

Multi-Rat and Throughput Aggregation

According to one or more embodiments, the moving system coverage will have areas on the ground where multiple satellites can provide service. In other words, multiple beams will cover those locations from different satellites. Having coverage from 2 or more satellites provides an opportunity for the UT in that region to receive higher throughput if equipped with sufficient antennas or a multi-beam antenna. A large file can be transmitted, for example, using Leo and meal satellite constellations in conjunction with the terrestrial link. Also, with this diversity, the UT can be dynamically scheduled over the beam/satellite that is less loaded in order to achieve a better Quality of Experience (QoE) to the end-user. Furthermore, a UT equipped with 2 antennas provides diversity as there could be scenarios and regulations that prevent the UT and the system from operating within specific directivity. For example, due to interference with another incumbent LEO or GEO satellite system using the same frequency. Multiple antenna, multiple RAT and in general multiple radio support provides the UT and the system with many options that improve user experience and resource utilization.

LEO satellite systems require continuous handovers due to the moving constellation and the UT is instructed to point to different satellite even if the UT is not moving unlike terrestrial cellular networks. During such handovers, a UT equipped with one antenna is required to retrace and synchronize to downlink transmission of the desired target satellite/beam. Depending on the antenna, the retrace time could be significant and would result in a service interruption and/or undesired application performance and/or end user experience. The retrace time is a function of the antenna type (mechanical or active electronically scanned array (AESA)), the angle of retrace etc. The use of 2 antennas can allow the non-active antenna to point and tune to target satellite and get ready while the active antenna still sending and receiving data traffic on the source beam/satellite. Furthermore, this leads to a minimal interruption during the frequent handovers as the one of the antennas is always ready to be activated on the target satellite/beam.

Quality of Service

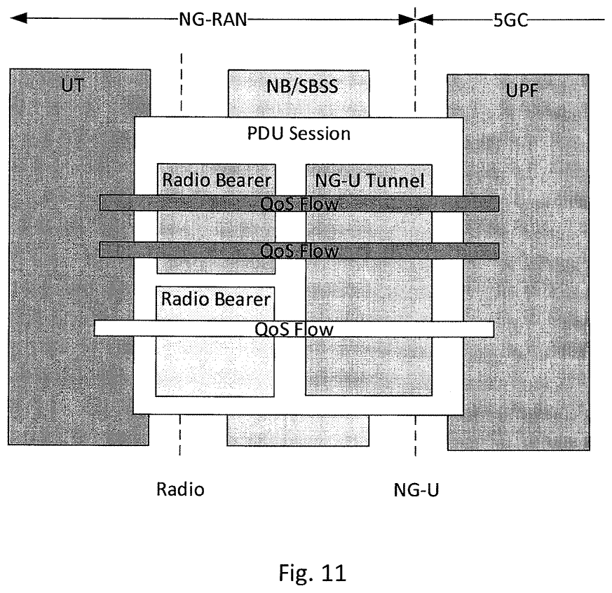

FIG. 11 illustrates a 5G QoS architecture, in accordance with one or more embodiments. The 5G QoS supports GBR Flow as well as Non-GBR Flow. Within a PDU session, a QoS flow is identified by a QoS Flow ID (QFI) carried in an encapsulation header over NG-U interface. NG-RAN maps packets belonging to different PDU sessions to different Data Radio Bearers (DRBs).

In the satellite system, the radio bearer is between the UT and the satellite RAN, similar to the terrestrial system where the radio bearer is between the UT and the gNB. In the multi radio configuration, the UT will have different RBs associated with different RATs and RANs.

Multi RAT Support and Data Traffic Routing

Multi RAT UT enables the UT to use the system that is more suitable depending on QoS, resource availability and other parameters, with the satellite system being the always present back up. A good example of this a cruise ship that goes out to sea and docks at various places with a good terrestrial cellular coverage. This requires a UT that possibly leverages the commonality of the protocol stacks between terrestrial and satellite access technologies or a UT with a dedicated protocol stack for each.

Given the above requirements of having multiple antennas with duplicate protocol stack and multiple RAT UTs, there are two viable solutions within the 3^{rd} Generation Partnership Project (3GPP) 5G framework. The first is Dual Connectivity (DC) and the second is Dual Stack Mobile IPv6 (DSM IPv6). These are distinct solutions and some of the difference of these two solutions impact where the split in the RAN/core network happen, how route or connectivity path decision is made, number of simultaneous connection and how dynamic path selection and traffic route can be made. These features enable satellite throughput aggregation, interference mitigation through satellite selection and/or terrestrial base station selection.

Dual Connectivity

Dual connectivity (DC) provides traffic routing through different transports based on availability and a multitude of criterions. Also, it allows the Main/Master Node (MN) to make decision on how much to rely on the “secondary” transport and for the type of traffic. The decision can factor in QoS and type of traffic, its delay sensitivity load experienced on main and secondary node. This applies, when throughput aggregation is done through a terrestrial RAT in addition to the Satellite System Radio Access Technology (SSRAT) or another SSRAT (i.e., a secondary satellite) in the UT coverage.

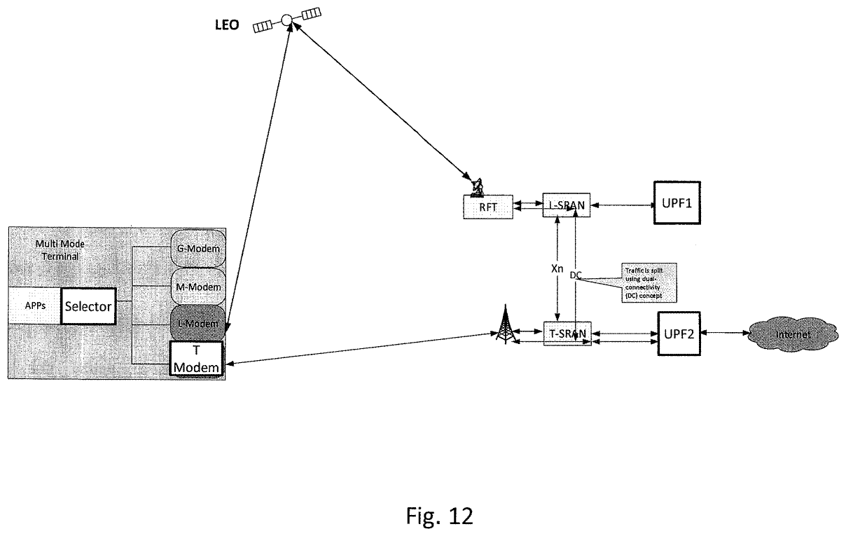

FIG. 12 illustrates dual connectivity terrestrial and LEO access, according to at least one embodiment. The terrestrial Access acts as MN and the LEO access acts as Secondary Node (SN). According to such embodiments, the UT can use different RATs to establish multiple sessions for connecting to a terminal. For example, a terminal may establish a terrestrial link for a voice channel, while establishing a Leo link for delay insensitive network data. The network data can be in the form of a PDF or other visual display file that is being discussed over the voice link. Each RAN can connect to other types of RANs using Xn interface to configure and forward data to the secondary node using a secondary radio interface. In the case of DC, during PDU session establishment or PDU Session Modification, the MN assigns some QFIs to be setup to MN and others to be setup to the SN. The DC involves RRC, Layer 2 (MAC/RLC/PDCP/SDAP sublayer), and layer 1.

DSM IPv6

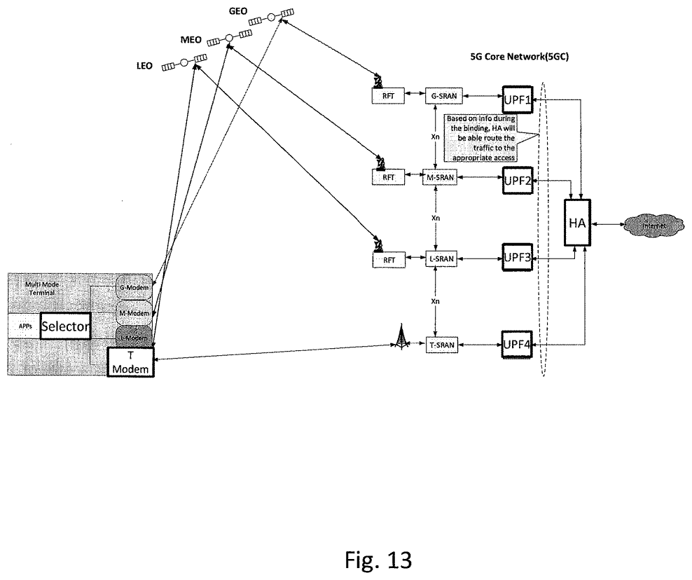

FIG. 13 illustrates a configuration for multiple constellations with DSM IPv6, according to one or more embodiments. As previously discussed, packet flows from/to the UT can be routed to either terrestrial, LEO, MEO or GEO depending on the characteristic of the flow. For example, a flow that requires a stringent delay specification will be routed via terrestrial system if available or via LEO system. On the other hand, a flow that is not delay sensitive will be routed via GEO system.

According to at least one embodiment, the UT can be configured to register via all available radio accesses and get multiple IP addresses associated with each radio access. In order to be able to bind all the IP addresses, the UT can be further configured to implement DSM IPv6 features. After a UT successfully registers to the 5G core for all its RAT and gets IP addresses, it communicates with the Home Agent (HA) located at the core network side to bind its IP addresses. During the binding process, the UT indicates the characteristic of the flows associated with each IP address. For example, IP addresses obtained via terrestrial or LEO can be associated with the delay sensitive flow, etc. FIG. 13 shows the use of DSM IPv6 in the satellite system where IP addresses of a UT are bound by the HA. Furthermore, each RAN is connected to a different UPF. However, the DSM IPv6 can also be applied in a system where all RANs are connected to the same UPF.

When the UT requests a new PDU session, the UT can associate every flow for the PDU session with different QFI, if necessary, depending on the characteristic of the flow. Based on the QFI, the UT will create radio bearer for each flow on different radio accesses. The HA will bind all the all the flows for the same PDU session and forwards them to the intended server. For the incoming data, the HA will route the flows for a PDU session into appropriate accesses based on the QFIs of the flows. For the uplink data, the UT routes the flows to the appropriate accesses/radio bearers based on the QFI of that flow. All flows from the same UT for the same PDU will be aggregated by HA. For the downlink data, the HA routes a flow to the appropriate access/radio bearer based on the QFI of that flow.

For the GBR flow, the access/radio bearer for the flow is also determined by its delay characteristic. For example, the GBR video traffic flow of QFI 4 can be routed via MEO/GEO since it is not as delay sensitive as voice traffic. The system also allows the flow to be re-routed to a different radio access if deemed necessary. For example, flow that is initially in the LEO can be re-routed to the MEO. According to at least one embodiment, a traffic management entity can be provided to monitor the traffic load for each path.

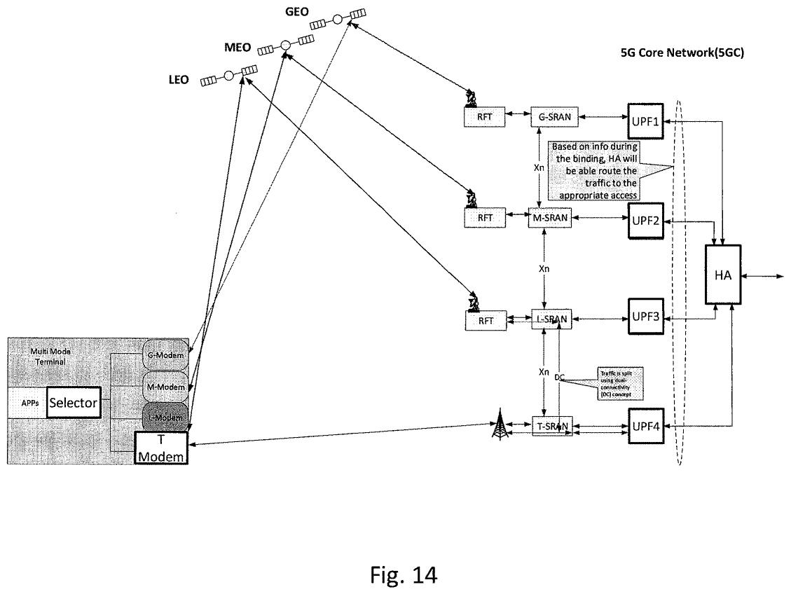

FIG. 14 illustrates dual connectivity and DSM IPv6 for multiple constellations. Dual-connectivity and DSM IPv6 can be used to enable the throughput aggregation, hence it will increase the total throughput of a UT. As shown in the illustrated embodiment, the traffic for a UT is split into the available accesses based on the characteristic of the traffic. Furthermore, in this example, the terrestrial RAN applies the DC techniques and splits some of the traffic to the LEO. This can be done, for example, if the LEO system is less loaded and also if splitting this flow will not sacrifice the QoS significantly.

QoS for Over-the-Top Application

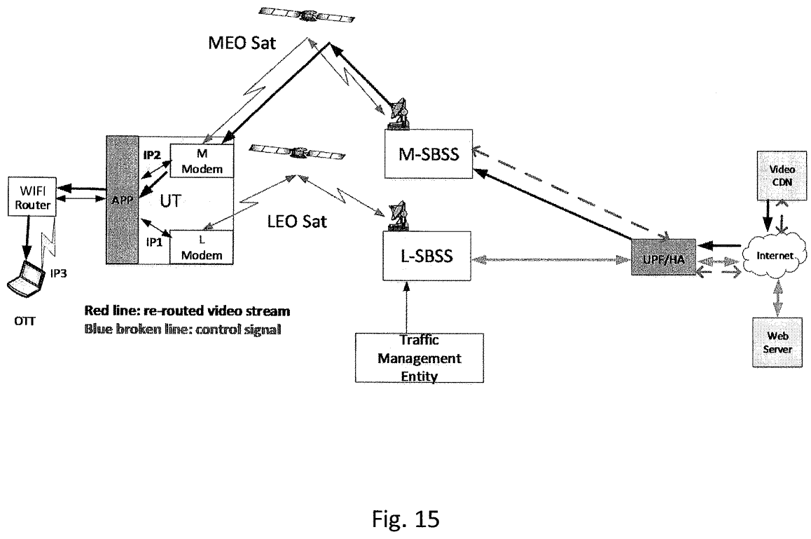

FIG. 15 illustrates a system with the traffic detector and traffic management entity. OTT traffic is usually encrypted and it is almost impossible for the UT to recognize it and to define QoS for it (e.g., when encrypted packets are not marked with a suitable DSCP indicator). For a UT configured to utilize multiple RATs, OTT flow will be routed to the LEO systems by default. However, the system will also have a feature that will be able to monitor and determine the type of OTT characteristic. One way is that the system will be equipped with the learning algorithm that is trained to detect different type of OTT traffic such as video or voice traffic, etc. Hence, once the type of OTT traffic has been defined, the system will instruct the UT to re-route the application to a more suitable radio access. According to various embodiments, the system illustrated in FIG. 15 can provide traffic-type based re-routing capability. For example, initially, the traffic is routed via LEO satellites. Later on, if it is determined that the OTT traffic is a downlink video traffic, the Traffic Management Entity instructs the terminal to re-route the OTT traffic to the MEO satellites because MEO satellites usually have a bigger bandwidth which is more suitable to a video traffic. There is also possibility that this OTT traffic is split into two different radio accesses. The video downlink is re-routed to the MEO downlink and the ACK is kept in LEO uplink. For this re-routing scheme to happen, the UT needs to bind all its IP addresses to the HA.

Depending on the specific type of traffic being transmitted, it may not always be possible for the terminal to identify the content or category of traffic being received. For example, some applications utilize traffic that does not use traditional port numbers, while other applications utilize encryption which prevent information such as the port numbers from being detected. According to at least one embodiment, deep packet inspection (DPI) can be applied to learn as much as possible about the flow of traffic being transmitted. Next, the different patterns identified from the deep packet inspection are analyzed in order to infer the type of traffic being carried. Thus, rather than waiting for the terminal to provide binding instructions, the home agent (HA) can utilize deep packet inspection in order to select the most appropriate RAT to be used for the traffic. The HA can periodically receive information pertaining to the specific RATs available to the terminal. Alternatively, the terminal can transmit information regarding available RATs anytime a change occurs. Once the HA selects a RAT for transmitting the packets, the terminal receives the packets via the appropriate physical layers and decodes them. The terminal simply routes the packets to the appropriate destination device.

Service and Session Continuity

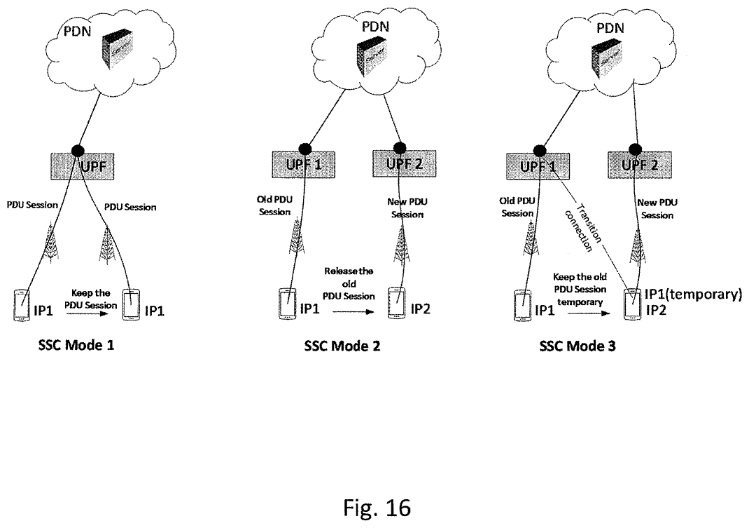

FIG. 16 is a diagram of 5G Session and service continuity (SSC) according to an embodiment. 5G defines three types of Service and Session Continuity (SSC) namely SSC mode 1, SSC mode 2 and SSC mode 3, as follow:

SSC mode 1: the network preserves the connectivity service provided to the UT. For the case of PDU session of IP type, the IP address is preserved.

the UPF, acting as PDU session anchor at the establishment of the PDU session, is maintained regardless of the access technology (e.g. Access Type and cells) a UT is successively using to access the network.

SSC mode 2, the network may release the connectivity service delivered to the UT and release the corresponding PDU session. For the case of IP type, the network may release IP address(es) that had been allocated to the UT.

The network may trigger the release of the PDU session and instruct the UT to establish a new PDU session to the same data network immediately.

At establishment of the new PDU session, a new UPF acting as PDU session anchor can be selected.

SSC mode 3, changes to the user plane can be visible to the UT, while the network ensures that the UT suffers no loss of connectivity. A connection through new PDU session anchor point is established before the previous connection is terminated in order to allow for better service continuity. For the case of IP type, the IP address is not preserved in this mode during relocation of the anchor.

The network allows the establishment of UT connectivity via a new PDU session anchor to the same data network before connectivity between the UT and the previous PDU session anchor is released.

For a UT that registers only via one radio access and the UT is handed over to a different radio access, e.g., from LEO to MEO, connected to the same UPF, the SSC mode 1 can be used. Hence there will be no IP address change. For a UT that registers via multiple radio access and then one radio access is not available and needs to be handed over to a different access with different UPF, SSC mode 3 is preferable since SSC mode 3 allows make-before-break connection. Such a UT can use multi-home PDU session to support make-before-break session. The SSC techniques are also applicable in the case of UT traffic needs to be re-routed for load balancing.

Mega Satellite Constellation as a Backhaul

Mega constellation LEO/MEO/GEO satellites can be used as a backhaul to carry the cellular traffic. In order to provide the QoS treatment for the cellular traffic, the satellite system needs to be able to recognize the cellular traffic flow characteristic. Since usually the cellular traffic between RAN and 5G core is encrypted, the QoS treatment for the cellular traffic can be applied by using the DSCP marking. The UPF and the RAN will assign the DSCP marking on the outer IP address that is recognized by the satellite system. DSCP marking can be used for traffic engineering and routing considerations.

Frequency Reuse

The mega constellation may also require a sizeable number of sites on the ground where the satellite RF signals lands. These sites will comprise PHY, MAC and RLC processing. PDCP functionality may be collocated with these sites or could be located elsewhere and anchored in order not to move the PDCP context at every gateway handover. The sites should ensure that the set of satellites that need to provide coverage have an associated gateway. The gateway sites must also be adequately connected to an IP network to carry all the satellite traffic to the core network, wherever it is located. The number of sites needed can depend on number of factors including target markets, feeder link redundancy to combat rain fade, natural disasters, regulatory requirements, etc. According to various embodiments a satellite operator could take advantage of these sites, as well as their physical and communication infrastructure and add NG-RAN to provide cellular coverage near these sites while reusing the same frequency bands as their satellite services in order to create additional value for their operating frequencies.

The primary advantage is that all the elements required to have NG-RAN are available, including the site, connection to the 5G core and the operation infrastructure of a 5G system. The other advantage is the ownership of the spectrum license with a primary use for satellite communication.

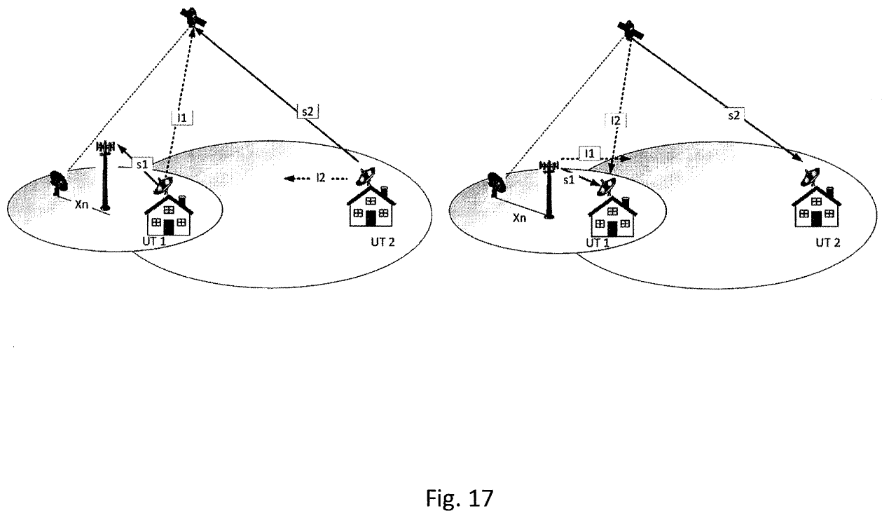

FIG. 17 illustrates signal and interference impact in terrestrial frequency reuse. First, the signal transmission and its interference I are examined in the return direction first. As illustrated in FIG. 17, UT1 is within ng-eNB macro cell coverage area and connected to it and UT2 is outside ng-eNB coverage area, and connected to the satellite gateway. The interference generated from UT1 toward the satellite is expected to be minimal given its transmit power toward the NR-GN. This is the case even if it is not using a directional antenna. However, UT2 transmission interference toward NG-RAN is a function of two elements. The first element is the angular separation between the direction of the serving satellite and the direction toward the ng-eNB. The second element is the UT transmit power and antenna pattern, specifically its side lobe patterns. Given the UT minimum elevation angle (MEA) for the satellite system operation, the UT antenna pattern, and the minimum distance of the UT from ng-eNB, it can be determined if the interference is acceptable, if a UT transmit power limit will be required, or if the frequency reuse is not a viable enhancement. Some mega satellite constellations are expected to operate with high UT MEA and would be more suited to explore frequency reuse in their deployments.

In downlink direction, low interference is expected from NG-RAN at UT2 for the same reason as above and the use of directional antenna at UT2. However, interference received at UT1 due to transmission toward UT2, or any UT under the satellite beam coverage, can be high. According to at least one embodiment, this interference can be addressed by first determining what is getting scheduled and transmitted through the satellite and an estimate of the received signal (i.e. interference). The NG-RAN can use Xn interface and low propagation delay to get the required information and apply some precoding techniques to overcome that interference and improve UT1 and all UTs under its coverage throughput. Satellite channel state information at UT1 may improve the interference estimate further instead of relying on prediction given UT position, beam patterns, path loss etc. We

Gateway Diversity Handovers

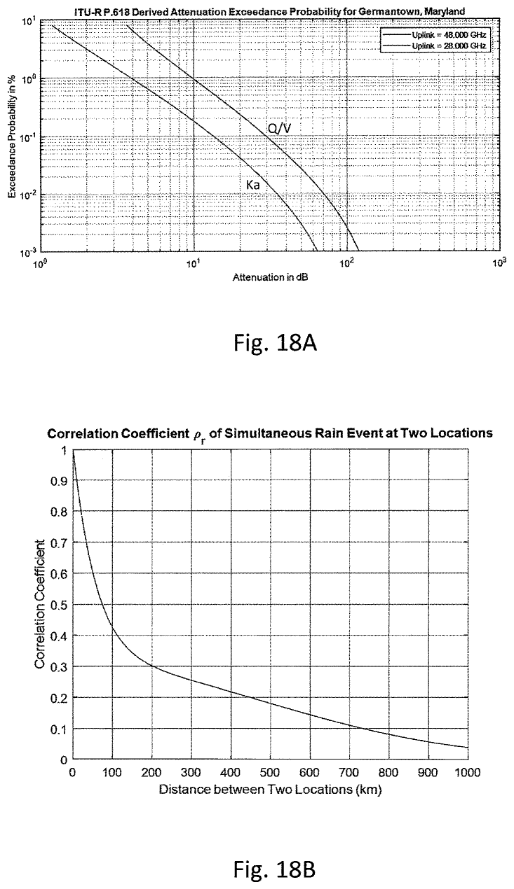

FIG. 18A is a plot of attenuation experience by Q/V band signals compared to Ka band signals. Q and V bands can provide larger bandwidth compared to Ka band. Q/V bands, however, are much more susceptible to atmospheric attenuation such as rain fade compared to Ka band. The curves represent a prediction of the total attenuation due to rain, cloud, atmospheric gases, depolarization and scintillation. As can be seen from this FIG. 18A figure, in order to achieve 99.9% availability, the feeder link should be able to handle about 30 dB of rain fade at Q/V band (48 GHz) compared to about 13 dB of rain fade needed with Ka band (28 GHz). Therefore, for the case of V and Q band deployment, rain diversity sites are deployed. Here each site is designed for 99% availability and a diverse site is deployed at a distance such that there is a very low correlation of rain events between the primary and diversity sites. According to at least one embodiment, the gateway location can carefully selected based on the statistics of rain fall induced attenuation.

FIG. 18B illustrates the correlation coefficient of simultaneous rain in diversity sites as a function of distance. The location of the gateways for robustness again rain induced attenuation can be based on the coefficient correlation of rain fall at two gateway sites which can be determined as:

$${ρ}_{r} = {0.7}^{( \frac{- d}{60} )} + {0.3}^{( - {( \frac{d}{700} )}^{2} )}$$

The smaller the coefficient correlation, the smaller the probability that these two sites have the same rain intensity. With the above method, it is possible to achieve close to 99.99% availability where each site is designed for an availability of 99%. It should be noted that it is not necessary to have one diversity site for every primary site. Multiple primary sites could share one diversity site as long as the probability of simultaneously raining in more than 1 primary site is negligibly small.

To maintain a high availability of the system, when a gateway detects the link to a UT is degrading below a specified threshold, the gateway starts the handover process for this UT to a more suitable gateway. The handover will follow the 5G Xn-based handover if the Xn interface is available. Otherwise the N2-based handover will be used.

Interference Management

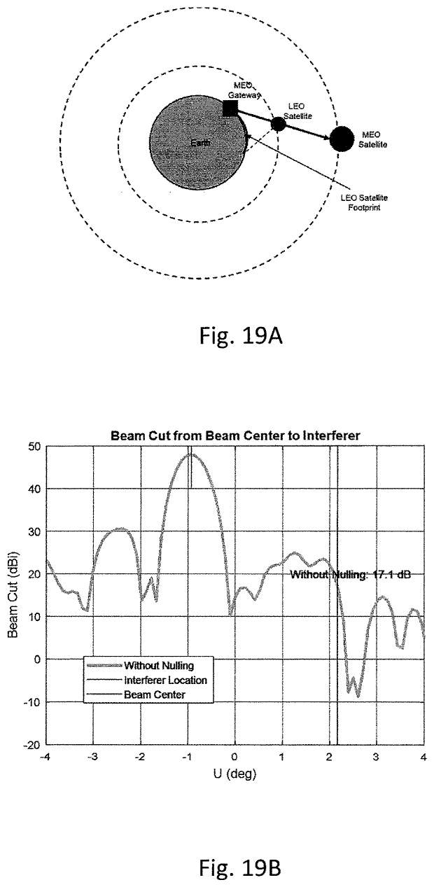

FIG. 19A illustrates an inline event between MEO gateway and LEO satellite. Mega constellations that include LEO, MEO, and GEO satellites are expected to use the same frequency (for example Ka band) in user link. Feeder links are also expected to use Ka band frequencies augmented by V and Q band frequencies, where possible. This implies that careful attention has to be paid to inter-constellation interference in addition to intra-constellation interference. To this end, intra-constellation interference can be mitigated by having directional antennas tracking the satellites in the constellation, and additionally having satellite antennas pointed towards gateway locations in the feeder link. Furthermore, traditional methods of frequency planning and satellite/beam ON/OFF schedules are used to manage intra-constellation interference.

However inter-constellation interference is much more challenging to manage since these co-ordinations have to be made potentially across operators. As illustrated in FIG. 19A, the gateway transmissions to the MEO satellite interferes with user terminal transmissions to the LEO satellite, because the geometry of the constellations relative to the MEO gateway creates an in-line event. It is noted that for this scenario, the gateway power is too high for the LEO satellite causing serious degradation in C/I for user signals belonging to LEO satellite constellation.

FIG. 19B illustrates the location of an interferer with respect to a return link beam in the satellite foot-print. This C/I impact not only affects the LEO beam in which the MEO gateway is in, but also nearly all other beams of the LEO satellite given the high power of the interferer. As illustrated in in FIG. 19B, the location of the interferer for this beam is such that the beam response is about 30 dB down from the beam peak, however if the MEO gateway power is about 25 dB higher (for a LEO at 800 km and MEO at 12,000 km above the surface of the earth, path loss difference itself is about 23 dB) than user terminals of LEO system, then C/I from this interferer alone will be close to 5 dB.

FIG. 19C illustrates beam response suppression with respect to known locations of interferers. According to various embodiments, on-board beam formers can be used to implement interference suppression techniques. Such techniques can effectively suppress interference form targets at known locations, such as the scenario described in FIG. 19A above.

According to at least one embodiment, the beam coefficients applied by the on-board beam formers can be continuously updated in order to address the changing location of the interferer. More particularly, the gateway remains in the same place while the satellite continues to move, thereby resulting in changes to the location of the interferer. According to at least one embodiment, all computations can be performed at the core network (i.e., 5G core) or NMS in order to reduce onboard complexity and computational requirements for the satellite. Once the computations are completed, the core network supplies the coefficients to the satellite for use by the onboard beam former.

FIG. 19D illustrates co-channel suppression feature to improve C/I and achieve higher throughputs. In the context of mega constellation systems, the location of interferer changes as a function of time due to the motion of LEO/MEO satellites relative to a fixed interferer on the ground. According to an embodiment, the beamforming coefficients are dynamically adjusted based on the location of the interferer with respect to moving beams. However, this time-varying interference location is predictable given the knowledge of satellite ephemeris and location of gateways across different constellations. While it is conceivable to have a ground based beamformer to handle dynamics of beam former coefficient computation, it may not always be practical given the amount of feeder link bandwidth that would be necessary. However, the above-mentioned interference suppression can be implemented even with an on-board beam former. In this case, a ground equipment at the core network can compute the beamforming coefficients ahead of time based on the knowledge of the location of interferer and the knowledge of ephemeris of mega constellation and load them to the satellite via telemetry or equivalent channels that controls the satellite payload. According to further embodiments, these interference suppressing beamforming coefficients can be loaded prior to and after the estimated in-line event time to account for uncertainties in knowledge of constellation ephemeris and pointing error of the gateway antenna. Such uploading could be done once every orbit and/or from the individual gateways that are in contact with the satellite multiple times in an orbit.

The concept of suppressing inter-constellation interference can also be used effectively in the case of intra-constellation interference. Here, the reuse cell (or beam) locations are identified relative to the cell (or beam) of interest and beamforming coefficients are optimized such that the beam responses at co-channel locations can be suppressed while sacrificing performance in non-co-channel locations. As illustrated in FIG. 19D, the interference resulting from the first interferer can be reduced by about 10 DB option is turned on. Similarly, co-channel interference can be suppressed by 15 dB and 12 dB for the 2^{nd} and 3^{rd} interferer locations, respectively. Furthermore, the improvements from co-channel interference are achieved with negligible loss in directivity.

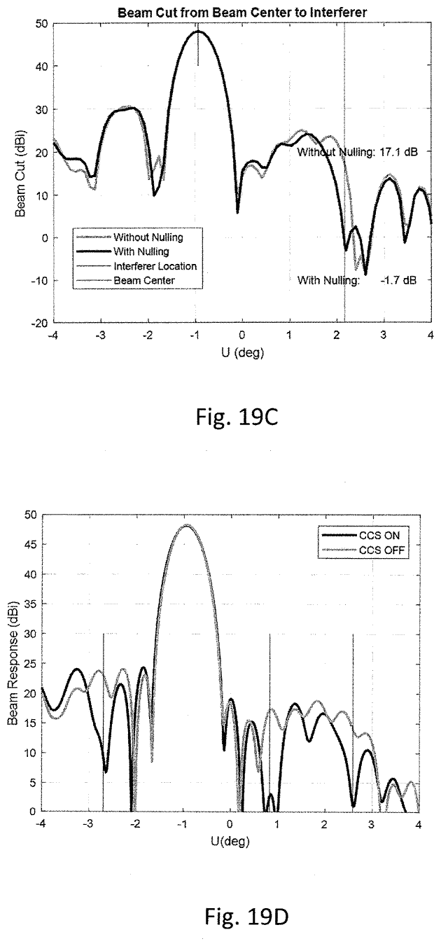

FIG. 20A illustrates non-uniform reuse factor implementation, in accordance with one or more embodiments. It is noted that this scheme is not restricted to reuse schemes that are uniform in the coverage area. Rather, it is possible to use non-uniform reuse schemes across the coverage area to cater to different applications that require different signal-to-noise ratios and provide improved capacity. It can be observed from FIG. 20A that frequencies f1, f2, f3, and f4 are used with a reuse factor of 4, whereas f5 is used with a reuse factor of 9. Furthermore, one of the beams uses both frequencies f1 and f5. The beamforming coefficients that are used for f1 for this beam will be different than f5 for the same beam. This is because the co-channel locations for f1 and f5 are completely different, and therefore different constraints would be used to optimize the beamforming coefficients for f1 and f5. In other words, the system is capable of implementing beam-forming capabilities on a per frequency basis based on where co-channels are located.

FIG. 20B illustrates time-varying loading of beams when serving hot-spots according to an embodiment. Mega constellations with LEO and MEO satellites that have satellite fixed beams are expected to provide near-global coverage. As the satellites move in their respective constellations, they will come across some regions in the satellite coverage area that are hot-spots and other regions where traffic demand is not high. It is noted that the beams that illuminate the hot-spot keeps changing as the satellite moves. At time t1, for example, the hotspot is covered by a first set of beams. As the satellite moves, however, the beams also move such that a different set of beams cover the hotspot at time t2.

According to at least one embodiment, a location-aware scheduler is utilized to determine the amount of traffic being carried in each of the co-channel sales within the hotspot. For purposes of illustration, the co-channels of interest are numbered 1-8. Thus, co-channel interference can occur in 8 out of the 31 cells illustrated. Since the location of the hotspot is known, the scheduler can determine that only 3 of the 8 cells of interest are carrying a heavy load of traffic, while the remaining 5 cells are not caring much traffic at time t1. The scheduler can take advantage of this information when determining the modulation and coding schemes to be used for users within the 8 beams, because the C/I ratio is better when other co-channel cells are lightly loaded vs. when all co-channel cells are uniformly loaded.

For example, if all cells are uniformly loaded at time t1, beam 5 would experience interference from cells 1-4 and 6-8. In contrast, if only the hotspot cells are loaded at time t1, then beam 5 will only experience interference from cells 4 and 7. As the interference is reduced, it becomes possible to utilize a more aggressive modulation and coding schemes. More particularly, if the interference is low, then less bits are required for coding the signal in order to reduce the probability of error associated with the interference. Conversely, if the interference level is high, then more bits are required for coding the signal to protect the data in order to minimize the probability of error from the interference. The scheduler therefore utilizes information pertaining to the activity in all interfering cells to select a modulation and coding capable of increasing the throughput within the hotspot while providing minimal adverse effects to the adjacent cells that are not caring much traffic. Accordingly, the scheduler can be designed to take advantage of the non-uniform distribution of traffic in active co-channel beams to use modulation and coding schemes commensurate with expected C/I, thereby improving spectral efficiency compared to a scheduler that only had visibility to the activity in the beam it was serving.

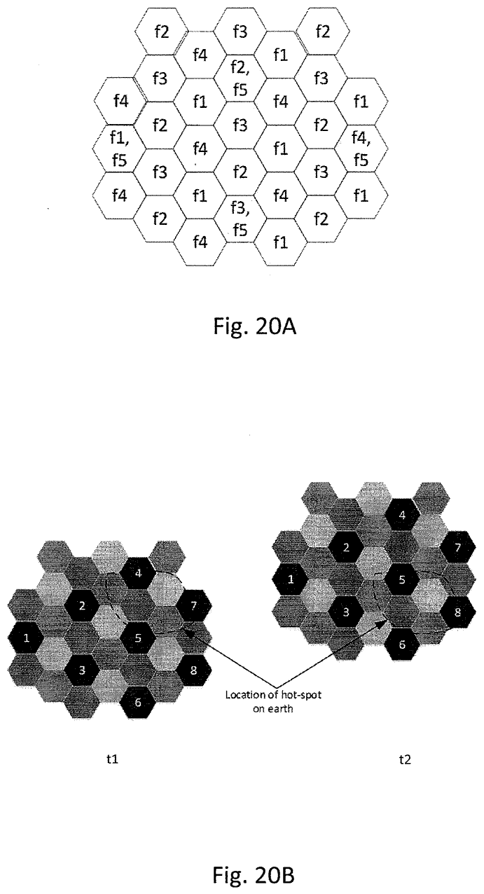

FIG. 21 is a plot of a non-uniform traffic pattern in different reuse cells. At time instance 1, there is only activity from co-channel cells 2 and 8. At the time instance 6, however, all 8 of the co-channel cells are active. Accordingly, the scheduler can use a more aggressive modulation and coding (i.e., less robust) at time instance 1 because the spectral efficiency will be higher. The scheduler can use a more robust modulation/coding at time instance 6 because all cells are active, thus resulting in a lower spectral efficiency.

According to at least one embodiment, the scheduler can be located in the gateway in order to access information regarding traffic passing through each beam of every satellite. For example, the scheduler could determine that there are very few packets in the queue for beams 1-4, 7, and 8 at time instance 0. However there are packets in the queue for beams 5 and 6 at time instance 0. Accordingly, the scheduler could conclude that a very aggressive modulation and coding scheme can be applied for beams 5 and 6 because there are no packets to be transmitted on the remaining beams.

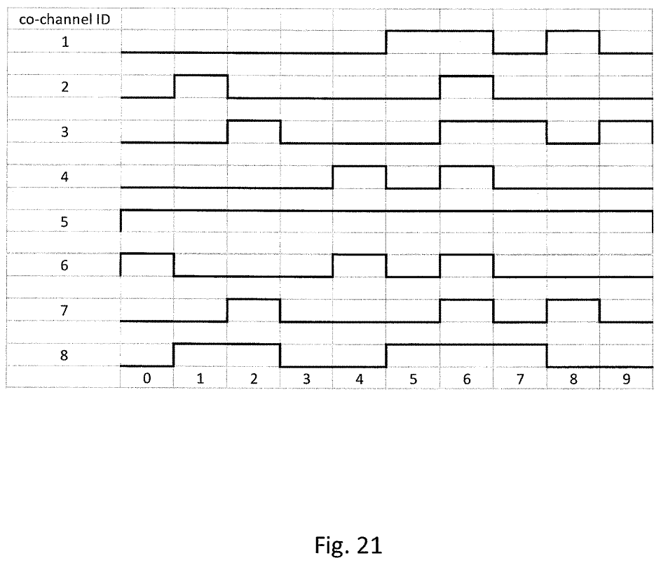

FIG. 22 is a plot of Spectral efficiency improvement achieved by location aware scheduling of the traffic pattern shown in FIG. 21. The spectral efficiency can be used as an indication of the throughput achievable given a particular level of co-channel interference. The higher the spectral efficiency, the greater the throughput that can be achieved. As illustrated in FIG. 22, a greater throughput is achieved at every time instance except 6.

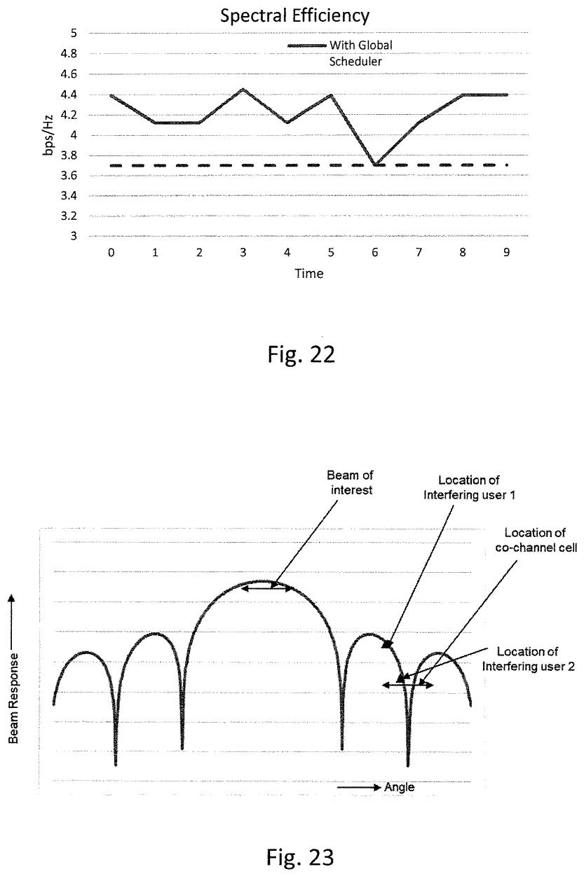

FIG. 23 illustrates a beam response plot for location aware scheduling in a return link. In the return link, the interference to a beam is dictated by where the users are located in co-channel cell regions in that beam's response. If a co-channel user is located where user-1 is shown, the interference to any user in the “beam of interest” region is higher than if the co-channel user were at the location of user-2. But it is the network scheduler which allocates resources to all users. Therefore network scheduler knows which users are being asked to transmit simultaneously in all co-channel cells. In this example, if the network schedules transmission from a user in the “beam of interest” region and user-1 simultaneously, then the user in the “beam of interest” region will be requested to transmit more robustly than if the network had not scheduled transmission for user-1. This way the scheduler is instructing the users in the “beam of interest” region depending on the location of the interfering users.

According to various embodiments, the gateway knows the location of each terminal as well as the antenna beam patterns for each satellite. By utilizing the location of interferers relative to the beam pattern, the scheduler can better predict the C/I a particular terminal will experience from an interferer. This information can also be used by the gateway to determine the best modulation and coding should be used by any terminal, depending on the number of interferers and their locations.

Various features described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Furthermore, various features can be implemented using algorithms illustrated in the form of flowcharts and accompanying descriptions. Some or all steps associated with such flowcharts can be performed in a sequence independent manner, unless otherwise indicated. Those skilled in the art will also understand that features described in connection with one Figure can be combined with features described in connection with another Figure. Such descriptions are only omitted for purposes of avoiding repetitive description of every possible combination of features that can result from the disclosure.

The terms software, computer software, computer program, program code, and application program may be used interchangeably and are generally intended to include any sequence of machine or human recognizable instructions intended to program/configure a computer, processor, server, etc. to perform one or more functions. Such software can be rendered in any appropriate programming language or environment including, without limitation: C, C++, C#, Python, R, Fortran, COBOL, assembly language, markup languages (e.g., HTML, SGML, XML, VoXML), Java, JavaScript, etc. As used herein, the terms processor, microprocessor, digital processor, and CPU are meant generally to include all types of processing devices including, without limitation, single/multi-core microprocessors, digital signal processors (DSPs), reduced instruction set computers (RISC), general-purpose (CISC) processors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components. Such exemplary hardware for implementing the described features are detailed below.

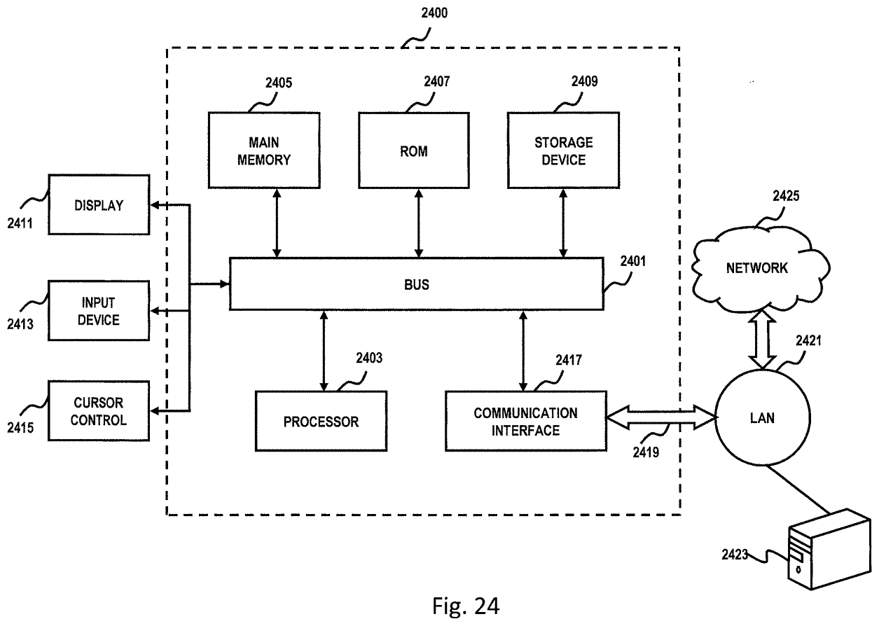

FIG. 24 is a diagram of a computer system that can be used to implement features of various embodiments. The computer system 2400 includes a bus 2401 or other communication mechanism for communicating information and a processor 2403 coupled to the bus 2401 for processing information. The computer system 2400 also includes main memory 2405, such as a random access memory (RAM), dynamic random access memory (DRAM), synchronous dynamic random access memory (SDRAM), double data rate synchronous dynamic random-access memory (DDR SDRAM), DDR2 SDRAM, DDR3 SDRAM, DDR4 SDRAM, etc., or other dynamic storage device (e.g., flash RAM), coupled to the bus 2401 for storing information and instructions to be executed by the processor 2403. Main memory 2405 can also be used for storing temporary variables or other intermediate information during execution of instructions by the processor 2403. The computer system 2400 may further include a read only memory (ROM) 2407 or other static storage device coupled to the bus 2401 for storing static information and instructions for the processor 2403. A storage device 2409, such as a magnetic disk or optical disk, is coupled to the bus 2401 for persistently storing information and instructions.

The computer system 2400 may be coupled via the bus 2401 to a display 2411, such as a light emitting diode (LED) or other flat panel displays, for displaying information to a computer user. An input device 2413, such as a keyboard including alphanumeric and other keys, is coupled to the bus 2401 for communicating information and command selections to the processor 2403. Another type of user input device is a cursor control 2415, such as a mouse, a trackball, or cursor direction keys, for communicating direction information and command selections to the processor 2403 and for controlling cursor movement on the display 2411. Additionally, the display 2411 can be touch enabled (i.e., capacitive or resistive) in order facilitate user input via touch or gestures.

According to an exemplary embodiment, the processes described herein are performed by the computer system 2400, in response to the processor 2403 executing an arrangement of instructions contained in main memory 2405. Such instructions can be read into main memory 2405 from another computer-readable medium, such as the storage device 2409. Execution of the arrangement of instructions contained in main memory 2405 causes the processor 2403 to perform the process steps described herein. One or more processors in a multi-processing arrangement may also be employed to execute the instructions contained in main memory 2405. In alternative embodiments, hard-wired circuitry may be used in place of or in combination with software instructions to implement exemplary embodiments. Thus, exemplary embodiments are not limited to any specific combination of hardware circuitry and software.

The computer system 2400 also includes a communication interface 2417 coupled to bus 2401. The communication interface 2417 provides a two-way data communication coupling to a network link 2419 connected to a local network 2421. For example, the communication interface 2417 may be a digital subscriber line (DSL) card or modem, an integrated services digital network (ISDN) card, a cable modem, fiber optic service (FiOS) line, or any other communication interface to provide a data communication connection to a corresponding type of communication line. As another example, communication interface 2417 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 2417 sends and receives electrical, electromagnetic, or optical signals that carry digital data streams representing various types of information. Further, the communication interface 2417 can include peripheral interface devices, such as a Universal Serial Bus (USB) interface, a High Definition Multimedia Interface (HDMI), etc. Although a single communication interface 2417 is depicted in FIG. 24, multiple communication interfaces can also be employed.

The network link 2419 typically provides data communication through one or more networks to other data devices. For example, the network link 2419 may provide a connection through local network 2421 to a host computer 2423, which has connectivity to a network 2425 such as a wide area network (WAN) or the Internet. The local network 2421 and the network 2425 both use electrical, electromagnetic, or optical signals to convey information and instructions. The signals through the various networks and the signals on the network link 2419 and through the communication interface 2417, which communicate digital data with the computer system 2400, are exemplary forms of carrier waves bearing the information and instructions.

The computer system 2400 can send messages and receive data, including program code, through the network(s), the network link 2419, and the communication interface 2417. In the Internet example, a server (not shown) might transmit requested code belonging to an application program for implementing an exemplary embodiment through the network 2425, the local network 2421 and the communication interface 2417. The processor 2403 may execute the transmitted code while being received and/or store the code in the storage device 2409, or other non-volatile storage for later execution. In this manner, the computer system 2400 may obtain application code in the form of a carrier wave.

The term “computer-readable medium” as used herein refers to any medium that participates in providing instructions to the processor 2403 for execution. Such a medium may take many forms, including but not limited to non-volatile media, volatile media, and transmission media. Non-volatile media include, for example, optical or magnetic disks, such as the storage device 2409. Non-volatile media can further include flash drives, USB drives, microSD cards, etc. Volatile media include dynamic memory, such as main memory 2405. Transmission media include coaxial cables, copper wire and fiber optics, including the wires that comprise the bus 2401. Transmission media can also take the form of acoustic, optical, or electromagnetic waves, such as those generated during radio frequency (RF) and infrared (IR) data communications. Common forms of computer-readable media include, for example, a USB drive, microSD card, hard disk drive, solid state drive, optical disk (e.g., DVD, DVD RW, Blu-ray), or any other medium from which a computer can read.

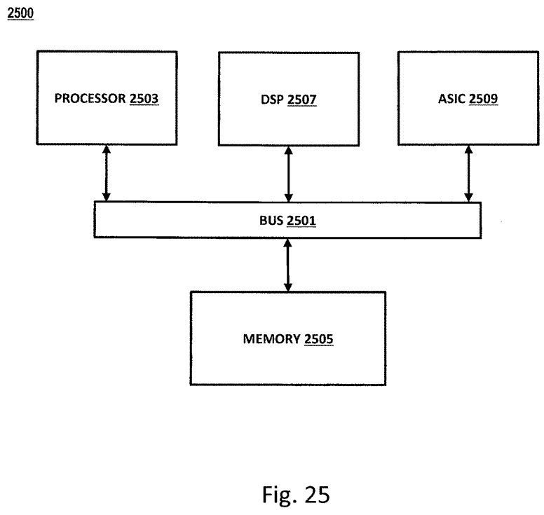

FIG. 25 illustrates a chip set 2500 upon which features of various embodiments may be implemented. Chip set 2500 is programmed to implement various features as described herein and includes, for instance, the processor and memory components described with respect to FIG. 25 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 2500, or a portion thereof, constitutes a means for performing one or more steps of the figures.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 2503 and accompanying components have connectivity to the memory 2505 via the bus 2501. The memory 2505 includes both dynamic memory (e.g., RAM, magnetic disk, re-writable optical disk, etc.) and static memory (e.g., ROM, CD-ROM, DVD, BLU-RAY disk, etc.) for storing executable instructions that when executed perform the inventive steps described herein. The memory 2505 also stores the data associated with or generated by the execution of the inventive steps.

While certain exemplary embodiments and implementations have been described herein, other embodiments and modifications will be apparent from this description. Accordingly, the various embodiments described are not intended to be limiting, but rather are encompassed by the broader scope of the presented claims and various obvious modifications and equivalent arrangements.

What is claimed is:

1. A method comprising:
establishing a communication link using a terminal configured for communicating with a plurality of radio access technologies (RATs);
determining a priority for network traffic associated with the terminal based, at least in part, on delay sensitivity associated with the network traffic;
classifying the plurality of RATs based on suitability for carrying the network traffic having the determined priority;
transmitting and receiving the network traffic using the RAT most suitable for carrying the network traffic and available to the terminal; and
dynamically monitoring RATS available to the terminal to detect if a more suitable RAT becomes available for carrying the network traffic.

2. The method of claim 1, wherein the RATs include LEO satellites, MEO satellites, GEO satellites, terrestrial landline networks, and wireless networks.
